(19) United States
(12) Patent Application Publication
(10) Pub. No.: US 2010/0245672 A1
(43) Pub. Date: Sep. 30, 2010

(54) METHOD AND APPARATUS FOR IMAGE AND VIDEO PROCESSING

(75) Inventors: Oliver Erdler, Ostfildern-Ruit (DE); Paul Springer, Stuttgart (DE); Carsten Dolar, Hannover (DE); Martin Richter, Dortmund (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/715,854

(22) Filed: Mar. 2, 2010

(30) Foreign Application Priority Data
Mar. 3, 2009 (EP) 09154206.8
Nov. 30, 2009 (EP) 09177525.4

(51) Int. Cl. H04N 5/217

(52) U.S. Cl. 348/608; 348/607; 348/E05.078

(57) ABSTRACT

The present invention relates to an image processing method. The method comprises a step of generating adaptive temporal filter coefficients. Then a recursive filter is applied at least once to an image frame using the generated temporal filter coefficients. The present invention further relates to an apparatus and a computer program product for performing image processing.

The present invention relates to a method and an apparatus for image and video processing. Specifically, the present invention aims at the reduction of image artifacts, especially analogue and digital noise.

The distribution of video content is nowadays not only possible via the traditional broadcast channels (terrestric antenna/satellite/cable), but also via internet or data based services. In both distribution systems the content may suffer a loss of quality due to limited bandwidth and/or storage capacity. Especially in some internet based video services as video portals (e.g. YouTube™) the allowed data rate and storage capacity is very limited. Thus the resolution and frame rate of the distributed video content may be quite low. Furthermore, lossy source coding schemes may be applied to the video content (e.g. MPEG2, H.263, MPEG4 Video, etc.) which also negatively affects the video quality and some essential information may be lost (e.g. textures or details).

A lot of source coding schemes are based on the idea to divide an image into several blocks and transform each block separately to separate relevant from redundant information. Only relevant information is transmitted or stored. A widely used transformation is the discrete cosine transform (DCT). As two consecutive frames in a video scene do in most cases not differ too much, the redundancy in the temporal direction may be reduced by transmitting or storing only differences between frames. The impact of such lossy coding schemes may be visible in the decoded video if some relevant information is not transmitted or stored. These visible errors are called (coding) artifacts.

There are some typical coding artifacts in block based DCT coding schemes. The most obvious artifact is blocking: The periodic block raster of the block based transform becomes visible as a pattern, sometimes with high steps in amplitude at the block boundaries. A second artifact is caused by lost detail information and is visible as periodic variations across object edges in the video content (ringing). A varying ringing in consecutive frames of an image sequence at object edges may be visible as a sort of flicker or noise (mosquito noise).

Coding artifacts are not comparable to conventional errors such as additive Gaussian noise. Therefore conventional techniques in error reduction and image enhancement may not be directly transferred to coding artifact reduction. While blocking is nowadays reduced by adaptive low-pass filters at block boundaries (either in-the-loop while decoding or as post-processing on the decoded image or video), ringing is more difficult to reduce, since the applied filtering must not lower the steepness of edges in the image content.

The reduction of quantization errors in block based coding schemes such as MPEG2 in video sequences can be done by a wide variety of algorithms. Basic classes are: Spatial lowpass-filtering (static or adaptive), multiband-processing (e.g. in the wavelet-domain) and iterative reconstruction techniques (e.g. projection onto convex sets).

The first class comprises algorithms that filter across block boundaries to smooth the discontinuity between two adjacent blocks. The strength and the length of the filter kernel for smoothing can be adjusted to image information (Piastowski, P.: “System zur Decoder-unabhängigen Reduktion von Blockartefakten”. 11. Dortmunder Fernsehseminar. VDE Verlag, (2005)).

The second class contains methods that apply a multiband decomposition in order to separate error and image information (e.g. by a warped wavelet transform Le Pennec, E. & Mallat, S.: “Sparse Geometrical Image Representations With Bandelets”. IEEE Transactions on Image Processing, Vol. 14, No. 4, April 2005) and to reduce the error in the subbands. After combining the subbands, the resulting image sequence should contain less error.

Algorithms of the third class try to establish a reconstructed image by formulating mathematical image properties the resulting image has to adhere, e.g. that the coded version of the resulting image needs to be the same as the coded input image (Zhong, S.: “Image Crompression by Optimal Reconstruction”. U.S. Pat. No. 5,534,925. July 1996). The algorithms usually try to solve an inverse problem with an iterative scheme (Alter, F.; Durand, S. & Froment, J.: “Adapted total variation for artifact free decomposition of JPEG images”. Journal of Mathematical Imaging and Vision, Vol. 23, No. 2. Springer Netherlands, 2005, Yang, S. & Hu, Y.: “Blocking Effect Removal Using Regularization and Dithering” IEEE International Conference on Image Processing, 1998. ICIP 98. Proceedings. 1998).

In some cases there has to be some further constraints on the image shape, for instance an image with minimal total variation is preferred over other solutions.

In most cases a spatial processing is preferred over the other algorithm classes due to its algorithmic simplicity which yields a good controllability and the possibility for a fast implementation. Furthermore, a solely spatial processing performs better than temporal based processing in scenes with fast movements, because the algorithm does not rely on motion vectors that might be erroneous.

The main disadvantages of spatial filtering algorithms for blocking reductions, however, are remaining blocking in homogeneous areas and remaining ringing artifacts at edges in the image. In an image sequence, the remaining errors can lead to a noise impression. Especially in content with low bitrate and low resolution (e.g. web TV or IPTV) the remaining artifacts are very annoying after a scaling process.

Therefore a specialized treatment for the remaining artifacts needs to be applied. In Devaney et al.: “Post-Filter for Removing Ringing Artifacts of DCT Coding”. U.S. Pat. No. 5,819,035. October 1998 an anisotropic diffusion filtering is proposed to reduce ringing artifacts. However, the processing proposed therein is designed for high quality material and lacks a prior de-blocking which is essential in this context since severe blocking artifacts (yielding high gradient values) are not processed at all.

Further, image quality is a major concern for modern flat panel displays. This is true on one hand for high-definition television (HDTV) and on the other hand also for low-quality material, for which the consumer wishes a HDTV-like representation on the respective displays. Therefore, advanced image processing methods for enhancing the input video signal processing are essential. To fulfill real-time requirements, non-iterative methods with a fixed runtime are preferably used in consumer television sets. These methods are tuned by an offline-optimization process and can additionally be adapted by image analysis. A drawback of this processing is that the output only depends on a-priori information. In contrast to this iterative reconstruction algorithms use image models and a feedback control loop to measure the achieved quality until an optimal solution is reached.

Methods for artifact reduction can be separated into spatial, temporal and spatio-temporal methods. Moreover it can be distinguished between methods working in the original domain (filters) and in the transform domain (e.g. DCT, Wavelet). Examples for pure spatial methods are adaptive and non-adaptive filter strategies. These methods are designed for coding artifact reduction and smooth the blocking boundaries dependent on the image content. Another spatial method is the 2D-regularization. Examples for pure temporal filters are the in-loop filter of the H.264/AVC standard or a method working in the wavelet domain. A spatio-temporal method for coding artifact reduction based on fuzzy-filtering is also known. This method uses the difference between the actual pixel and a reference pixel and thus the filtering is not dependent on the image content and therefore has to be combined with an additional image analysis. Also known is spatio-temporal regularization for coding artifact reduction. This method uses one motion compensated frame and the motion vectors are obtained from the encoder or decoder respectively.

One disadvantage of the spatial methods is a potential loss of sharpness due to filtering of similar but not the same image information. Due to the independent intra frame processing it is not possible to reduce flickering effectively.

Pure temporal filtering may result in high hardware costs due to the frame memories. Especially in homogenous regions spatial information can be used for filtering to reduce artifacts. Thus, the effectiveness of pure temporal filters is not satisfactory. Disadvantages of the existing spatio-temporal methods are that the filtering itself is not depending on the image content and thus a more complex image analysis for discriminating flat/edge/texture is required. Disadvantages of already existing spatio-temporal regularizing methods are the extreme complexity of computation, because they need the whole input sequence for processing of each frame, and the lack of handling non-smooth motion vector fields of real input sequences.

Other methods cannot be used because they are based on matrix operations with a high-computational complexity and assumptions that cannot be adapted to coding artifact reduction. Disadvantages of another method are that only one temporal motion compensated frame is used. Thus, the flicker reduction will not be sufficiently high.

It is therefore the object of the present invention to improve the prior art. It is further the object of the present invention to reduce the problems post by the prior art.

Specifically, the present invention has the object to present an apparatus, a computer program product and a method for image processing which allows to effectively reduce noise and coding artifacts in a video sequence.

This object is solved by the features of the independent claims.

Further features and advantages of preferred embodiments are set out in the dependent claims.

Further features, advantages and objects of the present invention will become evident by means of the figures of the enclosed drawings as well as by the following detailed explanation of illustrative-only embodiments of the present invention.

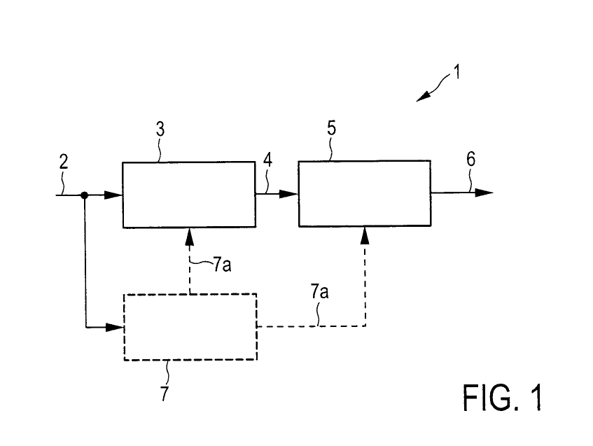

FIG. 1 shows a schematic block diagram of an apparatus according to a first embodiment of the present invention,

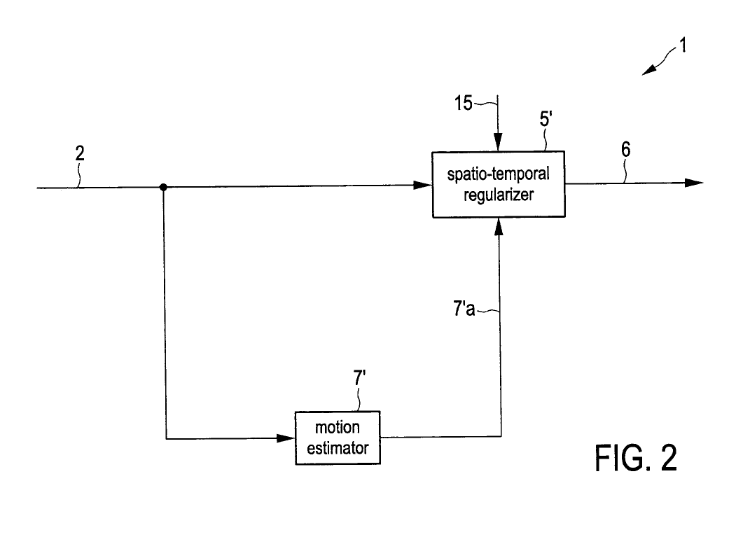

FIG. 2 shows a schematic block diagram of the apparatus according to a second embodiment of the present invention,

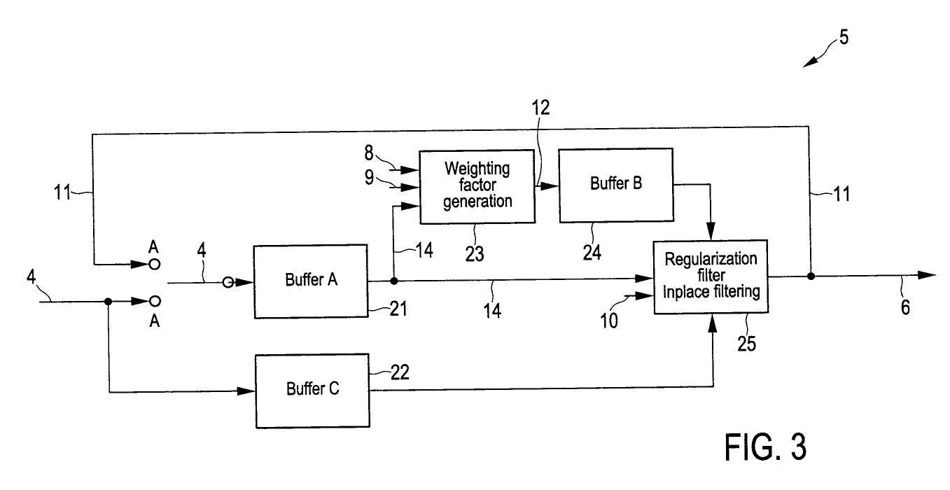

FIG. 3 shows a schematic block diagram of a regularizer according to the first embodiment of the present invention shown in FIG. 1,

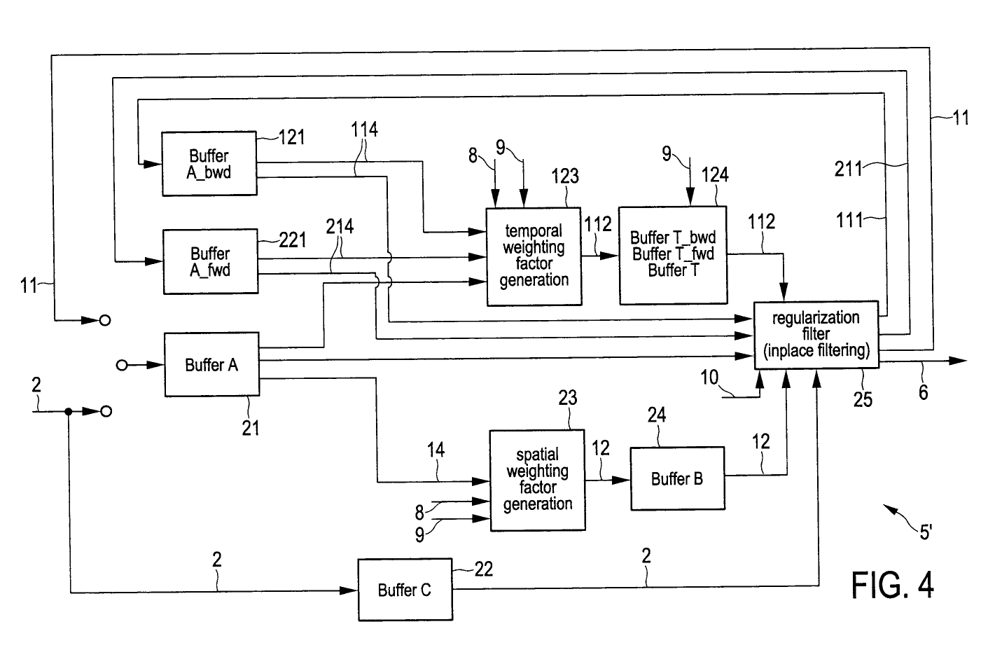

FIG. 4 shows a schematic block diagram of the regularizer according to the second embodiment of the present invention shown in FIG. 2,

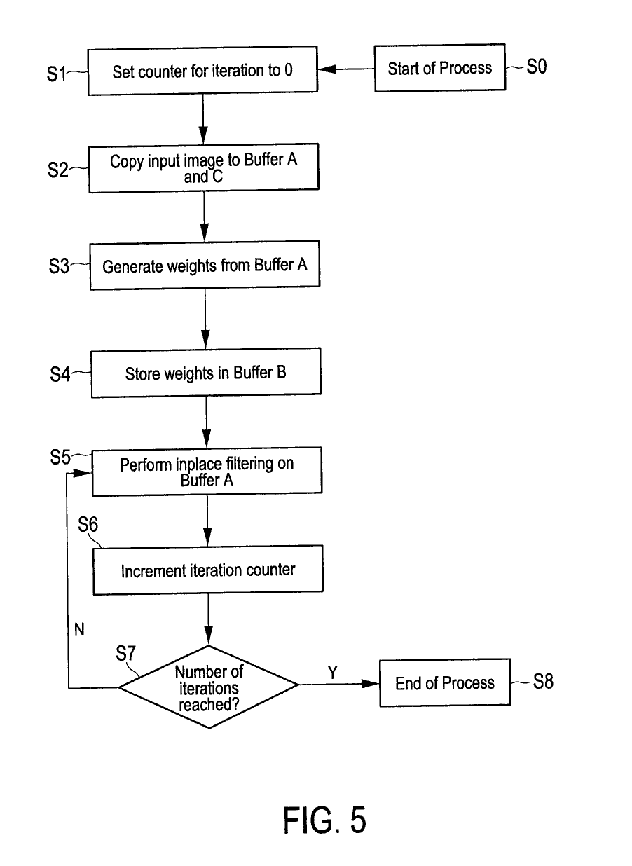

FIG. 5 shows a flow chart with the process steps according to a first embodiment of the present invention,

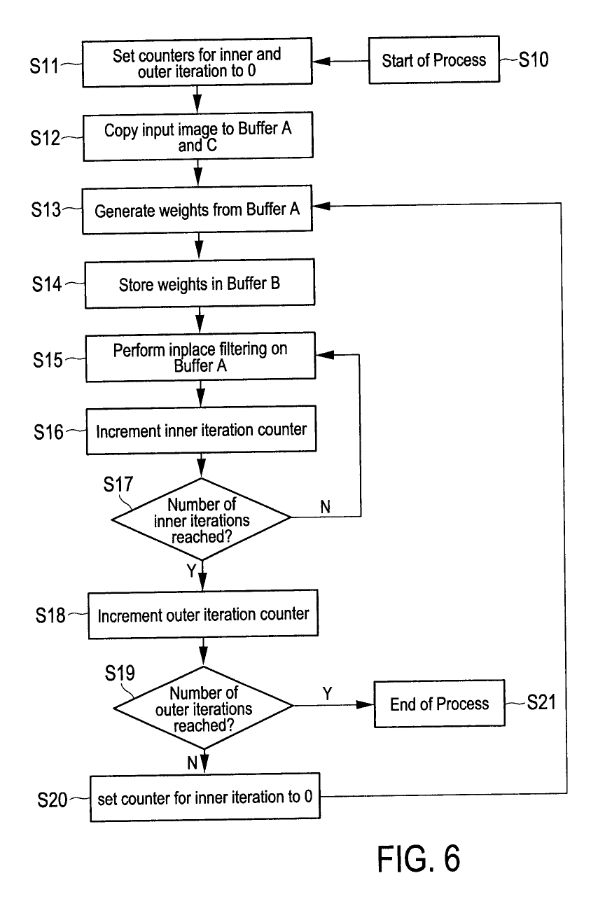

FIG. 6 shows a flow chart with the process steps according to a second embodiment of the present invention,

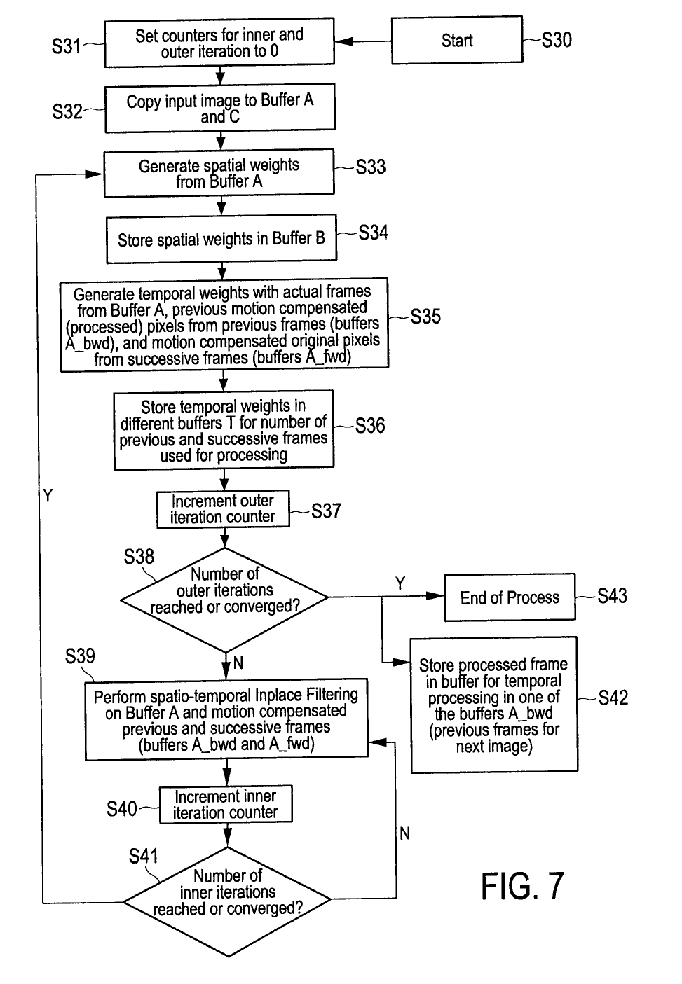

FIG. 7 shows a flow chart with the process steps according to a third embodiment of the present invention,

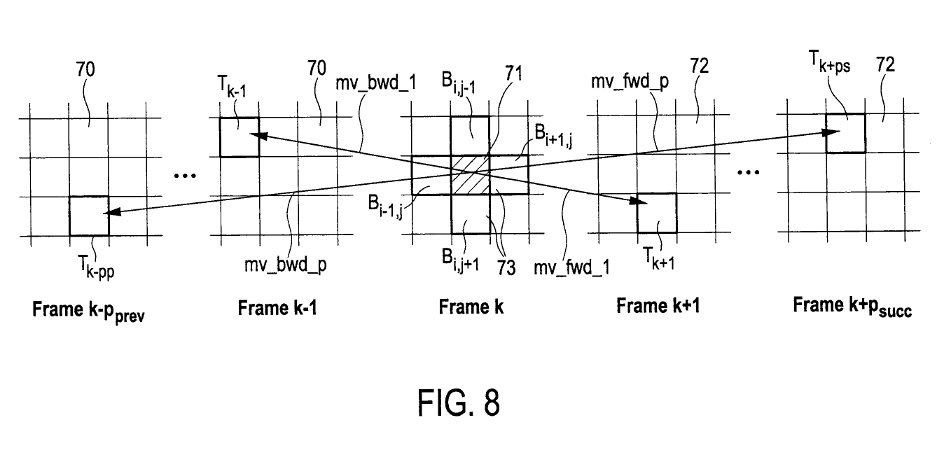

FIG. 8 shows a block diagram with example positions of spatial and temporal filter tabs,

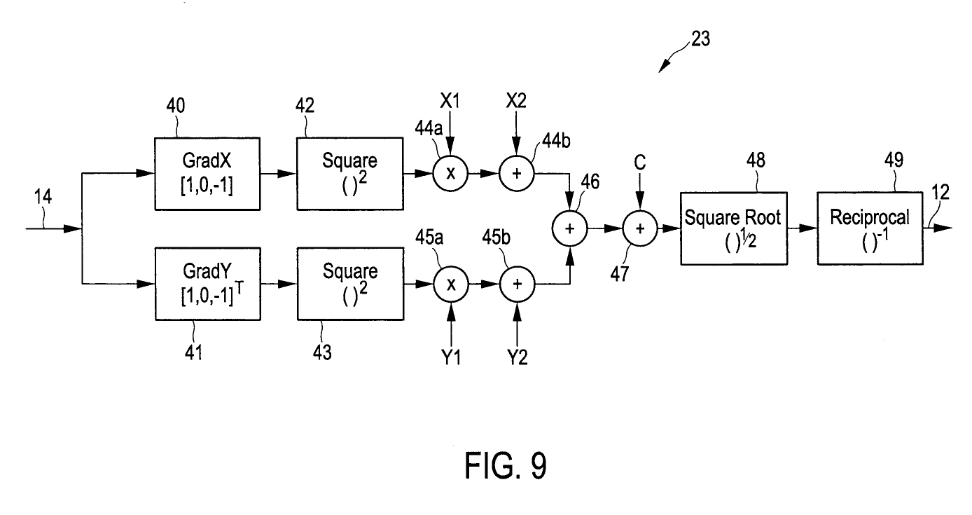

FIG. 9 shows a schematic block diagram of a spatial weighting factor generator according to a first embodiment of the present invention,

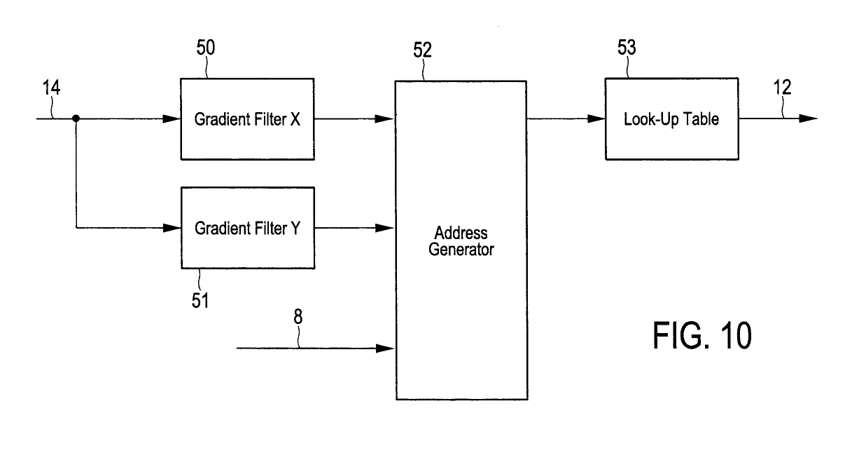

FIG. 10 shows a schematic block diagram of a spatial weighting factor generator according to a second embodiment of the present invention,

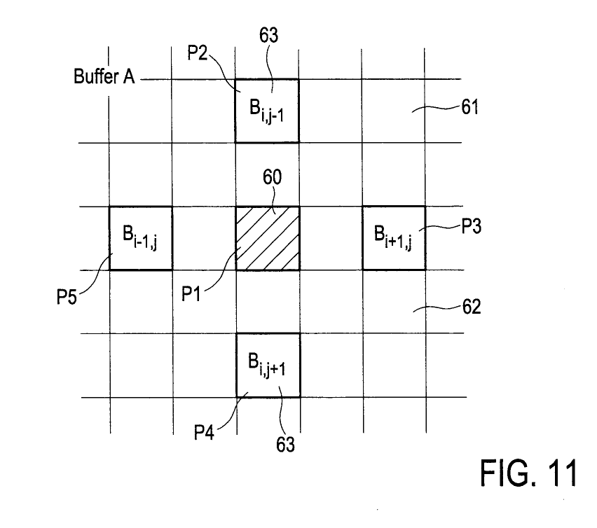

FIGS. 11 to 13 show different embodiments of a filter mask according to the present invention,

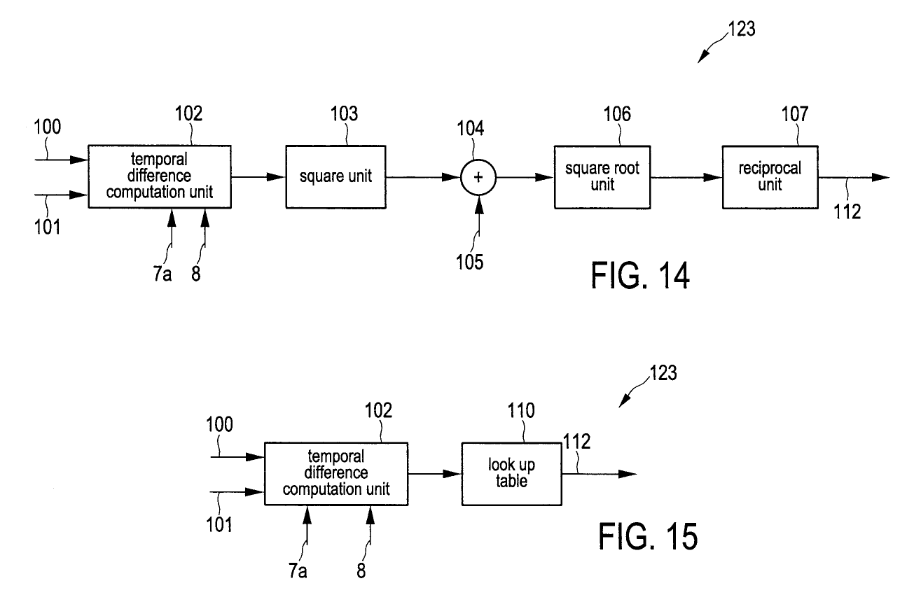

FIG. 14 shows a schematic block diagram of a temporal weighting factor generator according to a first embodiment of the present invention,

FIG. 15 shows a schematic block diagram of a temporal weighting factor generator according to a second embodiment of the present invention,

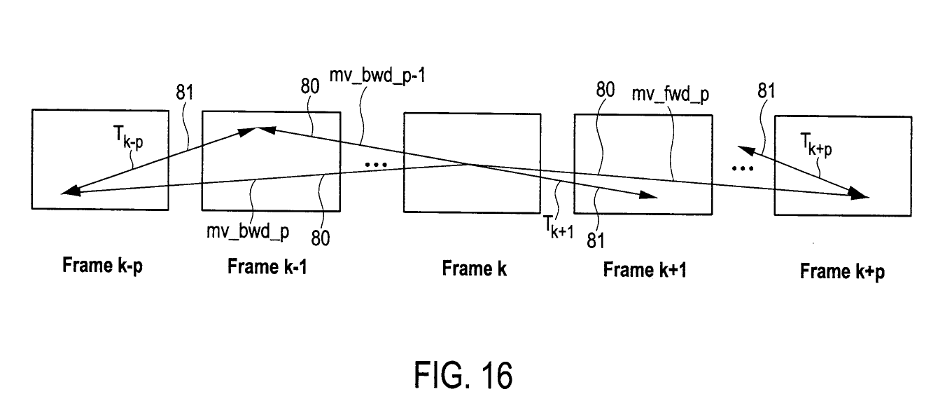

FIGS. 16 to 18 show different embodiments for calculating temporal differences between frames, and

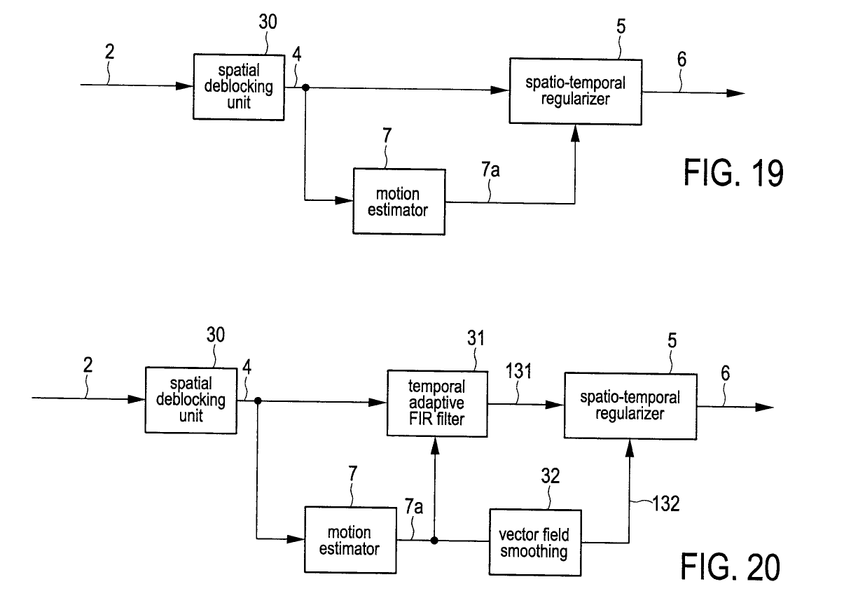

FIGS. 19 and 20 show different embodiments of combining the apparatus according to the present invention with a pre-processing.

FIG. 1 shows a schematic block diagram of an apparatus for reducing compression artifacts in a video signal according to a first embodiment of the present invention. The video signal hereby can comprise a single image or a sequence of images. The apparatus 1 comprises a block noise filter 3 for filtering discontinuous boundaries within the input image 2 and a regularizer 5 for smoothing the filtered image.

The input image 2 is submitted to the block noise filter 3. The block noise filter 3 can be any type of for example low-pass filter which is adapted to reduce the blocking artifacts. Preferably, a local adaptive low-pass filtering only across block boundaries is carried out. The reason for this pre-processing is the smoothing of discontinuities at block boundaries and to protect edges and details as far as possible. Any common de-blocking scheme can be used as block noise reduction algorithm, adaptive schemes with a short filter for detailed areas, a long filter for flat areas and a fallback mode are preferred.

The filtered image 4 is then submitted to the regularizer 5, which smoothes the filtered image 4. The processed image 6 is then output by the regularizer 5.

Optionally, according to a preferred embodiment an image analyzer 7 can also be provided. The input image 2 is also submitted to the image analyzer 7, which based on the input image 2 carries out image analysis. Specifically, the image analyzer 7 carries out the analysis step in order to detect certain image areas. For example the image analyzer 7 is adapted to detect edges, blocking level detection, textures or the like. The analysis information 7a can be submitted to the block noise filter 3 and/or the regularizer 5.

An advantage of using the analysis information 7a in the block noise filter 3 is that it is thereby possible to be independent from coding parameters, since the block noise filter 3 can use results from the local and/or global image analysis. In a preferred embodiment, the regularizer 5 uses the results of two different edge detection methods with different sensitivity to detect textured regions and prevent processing of these regions.

By combining the step of filtering by the block noise filter 3 with the step of smoothing the filtered image by the regularizer 5, an image with a higher quality than prior art methods is achieved. The deblocked and regularized processed image 6 is much more appealing than a deblocked image alone, since remaining blocking after the deblocking stage and ringing artifacts are reduced without blurring edges in the video content. Therefore, the proposed coding artifact reduction method is appropriate to enhance video material with low resolution and low data rate, since the processing maybe carried out aggressively to reduce many artifacts without suffering blurring in essential edges in the image.

In a preferred embodiment, as will be explained in detail later, the gradient values of the filtered image 4 and/or of a previously smoothed image are determined. The smoothing is then carried out depending on the gradient values, i.e. the level of smoothing is selected based on the gradient values. More specifically, a high level of smoothing is used for low gradient values and a low level of smoothing is selected for high gradient values. Thereby, artifacts are reduced while edges are maintained.

In other words, the regularizer 5 applies a harmonizing to the image, based on minimization of the total variation. According to the underlying mathematical model, this filter protects high gradient values in the image, small gradient values are smoothed, thus a mathematically optimal image with edges and flat areas is obtained. The image thus has an improved quality.

However, in order to further improve the image quality, the present invention in a preferred embodiment proposes to additionally analyse the image with respect to image areas, i.e. edges, textures or the like and to use this information for the regularization. Since with the basic method of regularizing an image without or blurred textures is obtained, this method even though representing the mathematical optimum does not lead to a good visual impression for natural images. The protection of certain image areas (regions with textures and high details) by an external image analyzer 7 is therefore provided in a preferred embodiment.

It has further been found in the present invention, that reduction of coding artifacts by simply applying the minimization of the total variation is not possible. Reason for this is that discontinuities at block boundaries can lead to high gradient values. Because the regularization obtains high gradient values by minimizing the total variation, blocking artifacts remain unprocessed. Therefore the degree of the degradation is not changed and the resulting output does contain the same or only slightly reduced blocking as in the input material leading to a bad image quality. Therefore it is not possible to use the same regularization method for Gaussian noise reduction (as proposed by e.g. Rudin/Osher/Fatemi) and for coding artifact reduction without strong modifications to the existing method.

Therefore, the present invention proposes an additional (adaptive) pre-processing step and a local adoption, which are accomplished by the block noise filter 3.

FIG. 2 shows a schematic block diagram of an apparatus 1 for image processing of a video signal according to a second embodiment of the present invention. The present invention hereby relates to image and video processing. The video signal hereby can comprise a single image or a sequence of images. For the spatio-temporal method according to the second embodiment of present invention, at least two frames are needed. In case that a pure spatial method is applied, as also described herein, the method can also be applied to one single frame.

The apparatus 1 shown in FIG. 2 comprises a spatio-temporal regularizer 5′, for carrying out at least a temporal regularization. Even though in the following, the present invention will be mainly described with respect to a spatio-temporal regularizing method, the present invention also comprises a pure temporal and a pure spatial regularizing method.

The input image or video signal 2 is submitted to the regularizer 5′, which processes the image as will be explained in more detail later on. The processed image 6 is then output by the regularizer 5′.

Optionally, according to a preferred embodiment a motion estimator 7′ can also be provided. The input image or video signal 2 in this case is also submitted to the motion estimator 7′, which based on the input image or video signal 2 carries out an image analysis. The motion information 7′a is then also submitted to the regularizer 5′.

Optionally, the regularizer 5′ can also use external information 15 from an image analysis to improve the results of the processing or to prevent over-smoothing of certain image regions.

Generally, the method according to this second embodiment (cf. FIG. 2) will be called spatio-temporal regularization or 3D-regularization. Hereby, the spatial regularization corresponds to the spatial regularization according to the first embodiment (cf. FIG. 1) and as described in European patent application EP 09 154 206.8 as filed on Mar. 3, 2009, which in the following will be referred to as EP application and which is incorporated herein by reference.

FIG. 3 shows a more detailed schematic block diagram of the regularizer 5 according to the first embodiment of the present invention shown in FIG. 1. First of all the input image 4 is fed to a first buffer 21, which is in the following called buffer A. The input image 4 is also fed to a second buffer 22, which in the following is called buffer C.

In the next step weighting factors 12 are generated by a weighting factor generator 23 based on the values stored in buffer A and the results, i.e. the weighting factors 12 are fed to a third buffer 24, which in the following is called buffer B. During computation of the weighting factors 12 it can be determined if a generation of new weighting factors 12 should be done or if the values (from previous iterations) in buffer B should remain there. The corresponding commands 9 indicating whether new weighting factors 12 should be calculated or whether the previous values should be kept, can be additionally submitted to the weighting factor generator 23. Additionally, it is possible to use external data 8 which is based on the results from the image analysis information 7a for weighting factor generation.

After this generation step for each pixel of the image stored in buffer A a weighting factor 12 exists, which is required for the regularizing filter 25. The regularizing filter 25 processes the data from buffer A and the processed output will directly be stored in buffer A. Thereby a filter structure with infinite impulse response is generated (described in literature as IIR-Filter or inplace filter). After processing of the image by the regularizing filter 25 the filtering can be applied again. In this case it is possible to prevent the generation of new weighting coefficients 12 to use the same weighting factors 12 from buffer B for this further iteration. This processing is advantageous in some cases. The amount of regularization, i.e. the level of smoothing, is controlled by the regularization rate 10.

For every pixel of an image stored in buffer A the regularization filter 25 applies the regularizing step and overwrites the same pixel value of the image presently stored in buffer A. The image submitted from the regularization filter 25 to buffer A will therefore be referred to a previously smoothed image 11. In case that the number of iterations is sufficient, then instead of storing the previously smoothed image 11 in buffer A this image is output as final processed image 6.

That means that weighting factors 12 are generated at least once and that with one set of weighting factors 12 one or more iterations within the regularization filter 25 can be accomplished. Via the commands 9 a generation of new weighting factors 12 for one or more iterations of the regularization filter 25 can be prevented.

Because this new method is a spatio-temporal or a pure temporal method, the processing is based on pixels of the actual frame and pixels from previous and/or successive frames. In case of motion, the pixels belonging to the same object are shifted from frame to frame. Thus motion estimation can be required to track this motion (shift) for processing of pixels sharing the same information in consecutive frames. As already mentioned, optionally, the processing of the spatio-temporal regularization can use external information 15 from an image analysis to improve the results of the processing or to prevent over-smoothing of certain image regions. This strategy is also described in the EP application for the spatial regularization e.g. to prevent over-smoothing of textured regions.

In the EP application it is illustrated that the mathematical formulation of the total variation can be derived into a simple IIR-Filter structure with adaptive filter coefficients. More specifically, the adaptive IIR-Filtering is applied several times to the image until a (mathematical) optimal solution is reached.

The method described in the present application is not based on a complete mathematical derivation. Instead it is based on a combination of the mathematical derivation in the EP application and additional heuristic assumptions, especially for the temporal weighting factors.

As will be described later, the result of these assumptions and derivations is a spatio-temporal IIR-Filter or pure temporal IIR-Filter, that is applied several times (iterations) to the actual frame using pixels from the actual frame and/or previous frames and/or successive frames. This filter structure can be found in equation (15) and in FIG. 8, but it will be presented later in detail. Between the iterations it is possible to generate new spatial and/or temporal weighting factors which depend on the newly processed pixel information.

The filter coefficients (weighting factors) and pixel positions in the actual frame used for the spatial filtering part of this invention are the same as described in the EP application.

FIG. 4 shows a more detailed block diagram of the regularizer 5′ according to the second embodiment of the present invention shown in FIG. 2. First of all, the input image or video signal 2 is fed to a first buffer 21, which in the following is called buffer A. The input image or video signal 2 is also fed to a second buffer 22, which in the following is called buffer C.

The currently stored information 14 from buffer A is submitted to a spatial weighting factor generator 23. The spatial weighting factor generator 23 generates the weighting factors based on the value stored in buffer A and the results, i.e. the spatial weighting factors 12, are fed to a third buffer 24, which in the following is called buffer B. During computation of the weighting factors 12 it can be determined if a generation of new weighting factors 12 should be done or if the values (from previous iterations) in buffer B should remain there. The corresponding commands 9 indicate whether new spatial weighting factors 12 should be calculated or whether the previous values should be kept, can be additionally submitted to the spatial weighting factor generator 23. Additionally, it is possible to use external data 8, which is based on for example external image analysis.

For purpose of temporal weighting factor generation, as shown in FIG. 4, at the moment of starting the process buffer A the current image frame is stored and in a further buffer 121, which in the following will be referred to as buffer A_bwd one or more previous image frames are stored and in a further buffer 221, which in the following will be called buffer A_fwd, one or more successive image frames are stored. For sakeness of clarity in the figure, the submission of previous and successive image frames to buffers A_fwd and A_bwd is not shown in FIG. 4. When describing FIG. 4 it is assumed that the corresponding frames are already stored in the respective buffers A, A_bwd and A_fwd.

From all buffers A 121, 221, 21 the stored data are submitted to a temporal weighting factor generator 123. The temporal weighting factor generator 123 generates temporal weighting factors 112 which are submitted to a buffer 124, which in the following will be referred to as buffer T. In a preferred embodiment separate buffers T, T_bwd, T_fwd are provided for storing the temporal weighting factors 112 generated from the different frames of the different buffers A, A_bwd, A_fwd.

It is to be noted that in case that only a temporal regularization is intended, Buffer B and the corresponding spatial weighting factor generator 23 can be omitted.

After this generation step for each pixel of the image stored in buffer A a temporal weighting factor 112 exists and optionally a spatial weighting factor 12, which is required for the regularizing filter 25. The regularizing filter 25 processes the data from buffer A and the processed output will directly be stored in buffer A. Thereby a filter structure with infinite impulse response is generated (described in literature as IIR-Filter or inplace filter). After processing of the image by the regularizing filter 25 the filtering can be applied again. In this case it is possible to prevent the generation of new weighting coefficients 12, 112 to use the same weighting factors 112 from buffer T and weighting factors 12 from buffer B for this further iteration. This processing is advantageous in some cases. The amount of regularization, i.e. the level of smoothing, is controlled by the regularization rate 10.

For every pixel of an image stored in buffer A the regularization filter 25 applies the regularizing step and overwrites the same pixel value of the image presently stored in buffer A. The image submitted from the regularization filter 25 to buffer A will therefore be referred to a previously smoothed image 11. In case that the number of iterations is sufficient, then instead of storing the previously smoothed image 11 in buffer A this image is output as final processed image 6.

That means that the weighting factors 12, 112 are generated at least once and that with one set of weighting factors 12, 112 one or more iterations within the regularization filter 25 can be accomplished. Via the commands 9 a generation of new weighting factors 12, 112 for one or more iterations of the regularization filter 25 can be prevented. Additionally, external analysis data 8 can also be submitted, including for example external image analysis and motion information, i.e. motion vectors, from a corresponding motion analysis.

The regularization filter 25 with the frames submitted from buffers A, the frame submitted from buffer C and the temporal and possibly spatial weighting factor carries out a regularization filtering, i.e. an in-place filtering within the buffers A. That means that the output results 11, 111, 211 are fed back from the regularization filter 25 to the respective buffers A so that several iteration steps for in-place filtering can be accomplished.

In the following, the regularization and specifically the spatial regularization will be described first in detail.

The regularization process introduces a smoothing along the main spatial direction, i.e. along edges to reduce the variations along this direction. Within the present invention the term “Regularization” is intended to refer to a harmonization of the image impression by approximation with an image model. The term “total variation” denotes the total sum of the absolute values of the gradients in an image which defines the total variation of the image. It is assumed that of all possible variants of an image the one with the lowest total variation is optimal. In the optimal case this leads to an image model, where the only variations stem from edges.

As the regularization is the key component in this invention, it will be described in more detail.

The basic idea of the regularization process is to reduce variations in an image (sequence) while preserving edges. In order to keep the resulting image similar to the input image, the mean square error must not be too big. The mathematical formulation of this problem is done by seeking an image (sequence) u that minimizes the energy functional:

$$E ( u ) = {\int }_{Ω} {( {u}_{0} ( x ) - u ( x ) )}^{2} d x + λ {\int }_{Ω} φ ( \vert gradu ( x ) \vert ) d x \qquad ( 1 )$$

In this formula u₀ denotes the input signal, u denotes the output signal, x is the (vector valued) position in the area Ω in which the image is defined. The function φ(s) weights the absolute value of the gradient vector of the signal u at position x. In literature there are different variants of how to choose this function, one being the total variation with φ(s)=s, another being φ(s)=\sqrt{s²+ε²}.

By applying the calculus of variation to (1) the following partial differential equation can be derived (omitting the position variable x):

$$( u - {u}_{0} ) - λdiv ( \frac{{φ}^{′} ( \vert grad u \vert )}{2 \cdot \vert grad u \vert} grad u ) = 0 \qquad ( 2 )$$

The term φ′(s)/2s gives a scalar value that depends on the absolute value of the gradient and that locally weights the gradient of u in the divergence term. As can be found in literature, the weighting function should tend to 1 for (grad u→0) and tend to 0 for (grad u→∞).

Known solving algorithms for (2) are for instance the gradient descent method or the “lagged diffusivity fixed point iteration” method. Both methods treat the term φ′(s)/2s as constant for one iteration step. For instance, the gradient descent method solving (2) is formulated as follows:

uⁿ⁺¹=uⁿ+Δτ((uⁿ−u₀)+λ div(bⁿ·graduⁿ)) (3)

This iterative scheme calculates directly the solution n+1 by using the results of step n. The initial solution is the input image (u⁰=u₀). The step-width Δτ influences the velocity of convergence towards the optimum but must not be chosen too big, since the solution might diverge. The weighting parameter

$${b}^{n} = \frac{{φ}^{′} ( \vert grad {u}^{n} \vert )}{2 \vert grad {u}^{n} \vert}$$

is calculated using the solution from step n as well. The results for this weighting function might be stored in a look-up table which gives two advantages. First, the weighting function can be directly edited, hence this circumvents the process of finding an appropriate function φ(s). Second, the look-up table can be used to speed up the calculation of the results of bⁿ by avoiding time demanding operations such as square, square root and division. The calculation of the divergence and the gradient can make use of known finite difference approximations on the discrete version of u, i.e. the digital image. Examples of a finite difference schemes in the two-dimensional case are:

$$grad u = ( \begin{matrix}{δ}_{x 1} ( u ) \\ {δ}_{x 2} ( u )\end{matrix} ) , \\ with {δ}_{x 1} ( u ) \approx 0.5 \cdot ( {u}_{( i + 1 , j )} - {u}_{( i - 1 , j )} ) , \\ {δ}_{x 2} ( u ) = 0.5 \cdot ( {u}_{( i , j + 1 )} - {u}_{( i , j - 1 )} ) \\ div ( \begin{matrix}{v}_{1} \\ {v}_{2}\end{matrix} ) \approx {δ}_{x 1} ( {v}_{1} ) + {δ}_{x 2} ( {v}_{2} ) \qquad ( 4 )$$

The regularization leads to a spatial low pass filter that adapts its filter direction based on the information generated with the function

$$\frac{{φ}^{′} ( s )}{2 s}$$

which assesses the absolute value of the local image gradient. The main filter direction is therefore adjusted along edges, not across, yielding a suppression of variations along edges and a conservation of its steepness.

There are several ways of adopting the regularizing process to local image analysis information other than the local image gradient: A first possibility is local manipulation of the value given by bⁿ based on local image analysis information by scaling of the gradient vector by directly weighting δₓ₁(u) and δₓ₂(u), adding a scalar or vector valued bias signal to the scaled gradient vector and/or scaling the value of bⁿ itself. A second possibility is locally adopting the weighting factor λ that controls the amount of regularization to the local image analysis information.

The adaptation with the first possibility has an influence on the direction of the divergence; the second possibility will adjust the amount of smoothing. The local adaptation can be introduced to equation (3) by multiplying the components of the gradient vector with an image content adaptive scaling factor (μₓ₁ and μₓ₂), adding an image content adaptive offset (νₓ₁ and νₓ₂), as well as multiplying the resulting weighting factor with an image content adaptive scaling factor γ. Those modifiers are derived from the external image analysis information.

$${u}^{n + 1} ( x ) = {u}^{n} ( x ) + Δτ ( ( {u}^{n} ( x ) - {u}_{0} ) + λ ( x ) div ( {b}^{n} ( x ) \cdot [ \begin{matrix}{δ}_{x 1} ( {u}^{n} ( x ) ) \\ {δ}_{x 2} ( {u}^{n} ( x ) )\end{matrix} ] ) ) \\ with {b}^{n} ( x ) = γ ( x ) \cdot \frac{{φ}^{′} ( s )}{2 s} and s = \vert ( \begin{matrix}{μ}_{x 1} ( x ) \cdot {δ}_{x 1} ( {u}^{n} ( x ) ) + {v}_{x 1} ( x ) \\ {μ}_{x 2} ( x ) \cdot {δ}_{x 2} ( {u}^{n} ( x ) ) + {v}_{x 2} ( x )\end{matrix} ) \vert \qquad ( 5 )$$

The image analysis information may contain information about the location of block boundaries, the overall block noise level in a region, the noise level in a region, the position and strength of edges in the image, region of details to be saved and/or other information about local or global image attributes.

The main drawback of the described gradient descent solving schema for the partial differential equation is that it converges relatively slowly and also might diverge when the wrong Δτ is chosen. To overcome these problems, the explicit formulation (3) is changed to an implicit formulation:

$$( {}_{u}^{n + 1}{-}{}_{u}^{0} ) + λ dv ( {}_{b}^{n} \cdot {gradu}_{ }^{n + 1} ) = C \qquad ( 6 )$$

The divergence at a given pixel position (i,j) is

div_{i,j}(bⁿ graduⁿ⁺¹)=0.25(u_{i-2,j}ⁿ⁺¹·b_{i-1,j}ⁿ+u_{i+2,j}ⁿ⁺¹·b_{i+1,j}ⁿ+u_{i,j-2}ⁿ⁺¹·b_{i,j-1}ⁿ+u_{i,j+2}ⁿ⁺¹·b_{i,j+1}ⁿ).

−0.25u_{i,j}ⁿ⁺¹(b_{i-1,j}ⁿ+b_{i+1,j}ⁿ+b_{i,j-1}ⁿ+b_{i,j+1}ⁿ)

using a central differences scheme.

This implicit formulation requires a solving algorithm which can for example be the iterative Gauss-Seidel algorithm.

The present invention is based on the spatial regularization which was described beforehand. Now, in addition the temporal regularization and the combination of spatial and temporal regularization will be described in more detail. Hereby, when denoting values such as A, B, C and T, the letters refer to the corresponding values stored in the respective buffers A, B, C and T which were previously described with reference to FIG. 4.

The temporal path (filter weights and position of filter taps) is based on heuristic assumptions. The mathematical derivation will now be explained in detail. Settings and motivation for some of the parameters will be described after the derivation is completed. The background of this derivation is presented in formula (7) and can be interpreted as an energy functional Eₖ for each frame k. It has to be noted that several motion compensated previous and/or successive frames are used for determining this energy functional:

$${E}_{k} = {\sum }_{i , j} {( {C}_{i , j , k} - {A}_{i , j , k} )}^{2} + {λ}_{spat} {\sum }_{i , j} {S}_{l} ( {A}_{i , j , k} ) + {λ}_{temp} \\ {\sum }_{i , j} {S}_{2} ( {A}_{i , j , k - {p}_{prev}} , … , {A}_{i , j , k} , … , {A}_{i , j , k + {p}_{succ}} ) \qquad ( 7 )$$

C are the pixels stored in buffer C from the actual input frame with actual spatial coordinate i, j and temporal coordinate k, the spatial regularizing parameter λₛₚₐₜ, spatial constraint S₁ (dependent on pixels in the spatial neighbourhood of the actual pixel at position i,j) and temporal regularizing parameter λₜₑₘₚ and temporal constraint S₂ (being dependent on actual frame, previous frames and successive frames). The pixels A stored in buffer A are already filtered or have to be updated.

In addition to the spatial term S₁ a temporal term S₂ is added. This temporal constraint is a sum over every reference frame (previous and successive ones) and will be explained later in detail. Using the approach illustrated in equation (7) the solution that minimizes the energy for frame k has to be determined as optimal output solution for frame k. This solution does lead to an image/sequence containing less artifacts than the actual input sequence:

$$arg {min}_{{A}_{n , m , k}} ( {E}_{k} ) \qquad ( 8 )$$

For the spatial constraint the formula presented in equation (9) is chosen. Even this spatial part is extended (e.g. h and b) and formulated more generally:

$${S}_{1} = \frac{1}{N} {\sum }_{n , m} {h}_{n , m}^{s} \cdot {b}_{i - n , j - m} \cdot {( {A}_{i - n , j - m , k} - {A}_{i , j , k} )}^{2} \qquad ( 9 )$$

With h^{s}_{n,m} being the same constant spatial filter coefficients for every pixel, b_{i-n,j-m} are adaptive filter coefficients (assumed to be independent of A_{i,j,k}) and N ist the number of non-zero filter coefficients. This spatial constraint can be interpreted as a sum of squared differences between actual pixel and neighbouring pixels thus being an activity measurement. The number of neighbouring pixels chosen for computation of the spatial constraint is dependent on the filter mask size n,m.

In analogy to the spatial constraint a temporal constraint S₂ is chosen:

$${S}_{2} = \frac{1}{P} {\sum }_{p} {h}_{p}^{t} \cdot {T}_{i , j , k + p} \cdot {( {A}_{i + {mvX}_{p} , j + {mvY}_{p} , k + p} - {A}_{i , j , k} )}^{2} \qquad ( 10 )$$

With h^{t}ₚ being the same constant temporal filter coefficients for each pixel, T_{i,j,k} the adaptive temporal filter coefficients (assumed to be independent of A_{i,j,k}) and P ist the number of non-zero temporal filter coefficients. A_{i+mvX}_{ₚ}_{,j+mvY}_{ₚ}_{,k+p} determines the pixels from (temporally) previous and successive (reference) frames. The pixel position in the reference frame has to be motion compensated by the motion vector components from the actual pixel to the reference frame (mvXₚ, mvYₚ). The temporal constraint of this invention uses temporal filter coefficients from a fixed temporal filter mask h and adaptive filter coefficients T determined by the image content and/or external information.

After the approach is completed the influence of each pixel on the whole energy functional has to be determined (applying the partial derivative with respect to each A_{i,j,k}). This methodology provides a solution strategy for a Least-Squares problem and results in the following formulae for S₁ and S₂.

$$\begin{matrix}\frac{δ}{δ {A}_{i , j , k}} {S}_{1} = - \frac{1}{N} {\sum }_{n , m} 2 \cdot {h}_{n , m}^{s} \cdot {b}_{i - n , j - m} \cdot ( {A}_{i - n , j - m , k} - {A}_{i , j , k} ) \\ and & ( 11 ) \\ \frac{δ}{δ {A}_{i , j , k}} {S}_{2} = - \frac{1}{P} {\sum }_{p} 2 \cdot {h}_{p}^{t} \cdot {T}_{i , j , k + p} \cdot ( {A}_{i + {mvX}_{p} , j + {mvY}_{p} , k + p} - {A}_{i , j , k} ) & ( 12 )\end{matrix}$$

After applying the partial derivatives to the whole energy functional depicted in formula (7) the condition for minimization yields the following equation for each pixel:

$$- 2 \cdot ( {C}_{i , j , k} - {A}_{i , j , k} ) - \frac{2 {λ}_{s}}{N} {\sum }_{n , m} {h}_{n , m}^{s} \cdot {b}_{i - n , j - m} \cdot ( {A}_{i - n , j - m , k} - {A}_{i , j , k} ) - \frac{2 {λ}_{t}}{P} {\sum }_{p} {h}_{p}^{t} \cdot {T}_{i , j , k + p} \cdot ( {A}_{i + {mvX}_{p} , j + {mvY}_{p} , k + p} - {A}_{i , j , k} ) {=}^{!} 0 \qquad ( 13 )$$

With the second and third term being the results of equations (11) respectively (12). This can be rewritten as:

$$( 1 + \frac{{λ}_{s}}{N} {\sum }_{n , m} {h}_{n , m}^{s} \cdot {b}_{i - n , j - m} + \frac{{λ}_{t}}{P} {\sum }_{p} {h}_{p}^{t} \cdot {T}_{k + p} ) {A}_{i , j , k} = {C}_{i , j , k} + \frac{{λ}_{s}}{N} {\sum }_{n , m} {h}_{n , m}^{s} \cdot {b}_{i - n , j - m} \cdot {A}_{i - n , j - m , k} + \frac{{λ}_{t}}{P} {\sum }_{p} {h}_{p}^{t} \cdot {T}_{i , j , k + p} \cdot {A}_{i + {mvX}_{p} , j + {mvY}_{p} , k + p} \qquad ( 14 )$$

After introducing a spatial offset for the computation of b the final result for computation of each pixel can be obtained (see equation (15)). This computation rule cannot be directly applied to the image/sequence because the values of A are not known. Therefore e.g. the Gauβ-Seidel Algorithm has to be used. This means that the values of A are consecutively actualised starting from the left-upper border of the image. Starting point of this process is the actual input image that is copied to buffer A. Then the input image is processed in a pixel-by-pixel manner from the upper left border to the lower right border overwriting the pixel values stored in A. In order to achieve a converged solution this process has to be iterated several times for each image. But as described in the EP application, even after one iteration a strong artifact reduction is possible and thus in certain applications (depending on the processing costs) it can be stopped after one or very few iterations before the mathematical (optimal) solution is reached.

$${A}_{i , j , k} = d \cdot ( \begin{matrix}{C}_{i , j} + \frac{{λ}_{spat}}{N} {\sum }_{n , m} {h}_{n , m , k} \cdot {b}_{{i - n - {o}_{1} ( n , m , k ) ,}_{j - m - {o}_{2} ( n , m , k ) , k}} \cdot {A}_{i - n , j - m , k} + \\ \frac{{λ}_{temp}}{P} {\sum }_{p} {h}_{i , j , k + p} \cdot {T}_{i + {mvX}_{p} , j + {mvY}_{p} , k + p} \cdot {A}_{i + {mvX}_{p} , j + {mvY}_{p} , k + p}\end{matrix} ) \\ with d = {( \begin{matrix}1 + \frac{{λ}_{spat}}{N} {\sum }_{n , m} {h}_{n , m} \cdot {b}_{{i - n - {o}_{1} ( n , m ) ,}_{j - m - {o}_{2} ( n , m )}} + \\ \frac{{λ}_{temp}}{P} {\sum }_{p} {h}_{i , j , k + p} \cdot {T}_{i + {mvX}_{p} , j + {mvY}_{p} , k + p}\end{matrix} )}^{- 1} \qquad ( 15 )$$

A_{i,j,k} are the pixels from the actual frame. i,j is the actual spatial position and the actual time instance is k. The spatio-temporal filtering is performed on buffer A, so the pixels left and/or above the actual position i,j are already processed/updated and the pixels right and/or below the actual position have to be updated. C_{i,j} is a buffer with pixels containing unprocessed values. By using these pixels for generation of the output value it can be controlled that the output has a certain similarity to the input value at the actual pixel position. The sum behind λₛₚₐₜ contains the filter weights and pixel values from the actual frame at time instance k. N is the number of pixels from the actual frame that are used for filtering, n,m is the relative position of the pixels to the actual pixel position i,j; h and b are the static and dynamic filter coefficients (see previous EP application) and A are the pixels in Buffer A that are used for filtering. The sum behind λₜₑₘₚ contains the filter weights and temporal pixel values from previous and successive frames. This part of the filter equation is new and a major step of the invention. The filter mask h_{i,j,k+p} determines a temporal static filter mask for the frame at time instance k+p. The weight for each reference frame can be controlled e.g. by this static filter mask. Because the correlation between pixels in the actual frame and pixels from a frame that has a high temporal distance to the actual frame is very low, it is reasonable to choose a small weight h for these temporally distant frames. For temporally adjacent frames a high weight h is chosen.

Buffer T contains the adaptively generated temporal filter coefficients. The generation of these coefficients is described later A_{i+mvX}_{ₚ}_{,j+mvY}_{ₚ}_{,k+p} determines the pixels from (temporally) previous and successive frames. It has to be noted that the pixel position has to be motion compensated by the motion vector components from the actual pixel to the reference frame (mvXₚ, mvYₚ). The number of frames used in the temporal direction is P in this example. It is possible to use the same number of frames for previous and successive frames or a different number of frames for previous and successive frames. By adopting the spatial and temporal regularization factors λₛₚₐₜ and λₜₑₘₚ it is possible to control the amount of smoothing in spatial and temporal direction. The higher the value of each regularizing parameter is, the stronger the smoothing is. The term d is a normalization factor to assure the sum of all coefficients being 1. The derivation described above is based on mathematical assumptions (Least Square problem and total variation model for constraints). Additionally to this mathematical derivation the following heuristics have been used. These heuristics are the free choice for the constant spatial and/or temporal filter coefficients hₛ respectively hₜ, the computation of the adaptive filter coefficients B and T and the offset of the spatial filter coefficients positions. The computation rules for B and T can be adapted to the situation, e.g. gradient protection as in Total Variation, blocking removal and/or flicker reduction. The computation of B and T is dependent on image/pixel information from neighbouring pixels/frames and/or external information from an external image analysis.

In case that only a temporal regularization is intended, then the spatial term in equation (7) will be set to zero by defining λₛₚₐₜ=0.

FIG. 5 shows a flow chart of the steps carried out for regularizing according to a first embodiment of the present invention. In case that the weighting factors 12 are only computed once, then the embodiment as shown in FIG. 5 is used.

The process starts in step S0. In step S1 the counter for the iteration, i.e. the iterations of the regularization filter 25, is set to zero. In the following step S2 the filtered input image 4 is stored in buffer A and buffer C. In the next step S3 the weighting factors 12 are generated based on the information stored in buffer A and optionally on external data. In the following step S4 the generated weighting factors 12 are stored in buffer B.

In step S5 the regularization filter 25 carries out in place filtering and the filtered, i.e. the smoothed image is then again stored in buffer A. In the next step S6 the iteration counter is incremented by one.

In the following step S7 it is checked whether the number of necessary iterations is reached; this can be a number of one or more, preferably an adjustable number of iterations which meets the computational constraints of given signal characteristics. If the number of iterations is reached then the process ends in step S8. Otherwise the process continues with step S5 and again the inplace filtering is accomplished.

FIG. 6 shows a second embodiment of regularizing the image, whereby this embodiment covers the possibility that the weighting factors 12 are generated more than once.

The process starts in step S10. In step S11 counters for inner and outer iteration are set to zero. In the following step S12 the filtered input image 4 is copied to buffer A and buffer C.

In the next step S13 the weighting factors 12 are generated based on the information stored in buffer A and optionally based on external image analysis information. In the following step S14 the generated weighting factors 12 are stored in buffer B and in the following step S15 the inplace filtering by the regularization filter 25 is performed and the processed filtered values are stored in buffer A.

In the following step S16 the inner counter is incremented indicating the number of inplace filter iterations. In the next step S17 it is checked whether the number of inner iterations is reached. Preferably, the number of inner iterations being sufficient is an adjustable number of iterations which meets the computational constraints or given signal characteristics. Otherwise it can also be checked whether the maximum difference between the previously smoothed image 11 and the actual processed image is less than a certain value. If the number of inner iteration is not reached, then the process goes back to step S15. Otherwise, the process continues with step S18.

In step S18 the outer iteration counter indicating the number of times weighting factors 12 are created is incremented by one. In the following step S19 it is checked whether the number of outer iterations is reached. Preferably, the number of outer iterations is set to an adjustable number of iterations which meets the computational constraints or given signal characteristics but also any other number of outer iterations being more than one is possible.

If in step S19 it is decided that the number of outer iterations is reached, then the process ends in step S21. Otherwise the process continues with step S20 in which the counter for the inner iteration is reset to 0 and then returns to step S13 where new weighting factors 12 are generated based on the information stored in buffer A.

FIG. 7 shows a flowchart of the steps carried out for regularizing according to a third embodiment of the present invention. Even though this flowchart describes a combined spatio-temporal regularization, the present invention is not limited to this kind of regularisation but can also comprise a pure temporal or a pure spatial regularization.

It has to be noted that this flow diagram is based on the flow diagram of the methods shown in FIGS. 5 and 6. The solving scheme used for the spatio-temporal regularization is the same as the one for the spatial case. Thus, an outer and an inner iteration are used to perform the spatio-temporal recursive filtering. In the outer iteration the spatial and temporal weights are computed that are necessary for the spatio-temporal filtering. It is also possible to by-pass the generation of the filter coefficients (spatial and/or temporal by-pass) and to use the weighting factors from a look-up table or a previous iteration again.

The process starts in step S30. In step S31 the counters for inner an outer iteration are set to zero. The naming of the buffers is the same as described with reference to FIG. 4. Buffer C is the buffer of the actual unprocessed image, buffer A is the buffer of the actual frame that is processed (that has to be updated, named A_{i,j,k} in equations (7)-(19)), and this buffer can contain (a) the unprocessed image before all iterations, (b) a partly processed image during every iteration and (c) a processed image after each iteration. As described below, the spatio-temporal filtering is performed on buffer A, but also the previous and successive frames are necessary for spatio-temporal filtering.

The previous frames are already processed and stored in buffers that are named A_bwd. Note that the number of the buffers A_bwd is dependent on the number of previous frames used for processing. A typical number of previous frames used for processing is between 1, in case a conventional motion estimation is used, and 3-7 if a multiple reference frame motion estimation is used. Note that these previous frames are already processed (compare FIG. 8). It is to be noted, that an additional mode is possible were non-processed previous frames are used. This can make sense in case of real-time or parallel processing. The non-processed successive frames are stored in the Buffers A_fwd. In analogy to the previous frames, the number of fwd Buffers is dependent on the number of successive frames used for processing. A typical range of values is also between 1 and 7.

In step S32 the input image 2 is copied to buffers A and C. In the next step S33 the spatial weighting factors 12 are generated from buffer A and stored in buffer B in step S34.

After computation of the spatial weighting factors using one of the methods and strategies which will be described later on, the temporal weighting factors for each pixel and (inner) iteration are computed in step S35 by using the methods described later on. Note that for each previous and successive reference frame one buffer for the temporal weights is required, even though in FIG. 4 for the sake of clarity only one single buffer T is shown. The temporal weighting factors 112 are thus stored in buffer T in step S36.

In the next step S37 the outer iteration counter is incremented. In step S38 it is checked, whether the number of outer iterations or convergence is reached. If this is the case, then the process for this frame ends in step S43. At the same time, the processes frame is stored for temporal processing in one of the buffers A_bwd, so that it can be used as previous frame for the next image frame). Also, at the same time, the final processed image frame 6 is output in step S42.

Otherwise, if in step S38 it is decided that the number of outer iterations is not yet reached, then in the next step S39 in-place filtering is performed. In step S40 the inner iteration counter is incremented and in step S41 it is checked, whether the number of inner iterations or convergence is reached. If this is the case, then the process goes back to step S33 and new weighting factors are generated. Otherwise, the process goes back to step S39 and again the in-place filtering is performed, as explained in more detail in the following.

After computation of all spatial and temporal weights the spatio-temporal in-place filtering on the actual frame (that is in Buffer A) is performed. This in place filtering can be repeated for the desired number of inner iterations. A typical value for the number of inner iterations is between 1 and 7. The exact number is dependent on the input quality of the sequence and the hardware requirements. The spatio-temporal in-place filtering is described in equation (15). After the number of inner iterations is reached, new filter coefficients can be computed in the outer iteration. The process flow stops when the desired number of outer iterations is reached. In this case the actual frame must be stored in one of the previous buffers A_bwd to use this frame for the computation of the temporal weighting factors for the next actual frame. Additional remark: In case the number of the previous and successive frames is set to 0 or if λₜₑₘₚ is set to 0, the result is a pure spatial regularization as it is described in the EP application. Thus, the spatial regularization can be integrated into this spatio-temporal regularization method. Another possibility is to set λₛₚₐₜ to 0. In this case a pure temporal regularization can be obtained.

With reference to FIG. 8 now the spatio-temporal filtering process will be explained in more detail using as example one current frame k, two previous frames k−1 and k−pₚᵣₑᵥ and two successive frames k+1 and k+p_{succ}. However, the present invention is not limited to the use of two previous and two successive frames, but any number of previous and/or successive frames can be used. In the following, only as an example for explaining the process, two previous frames and two successive frames are used.

FIG. 8 illustrates the spatio-temporal filtering process. The pixels 70 that are already filtered/processed in the previous frames are painted in grey, the actual (processed) pixel 71 is dashed and the pixels 72 that have to be processed are not painted.

Several things have to be noted. For the spatial filter coefficients every mask and position as described in later on can be used. Therefore the positions of the reference pixels 73 being part of the filter mask as shown in FIG. 8 are non-limiting examples.

For the computation of the temporal weighting factors different strategies can be used, too. These strategies will be described later on.

The previous frames are already processed in this example. As described before, the spatio-temporal IIR-Filtering can be applied iteratively (certain iteration number K). In this case the pixels 70 in the previous frames (Frame k−p . . . Frame k−1) are completely processed (i.e. all iterations are completed for these frames). The pixels 71 in the actual frame are partially processed. In addition to the example depicted in FIG. 8 it is possible to use previous frames that are not processed for generation of the temporal weighting factors and/or filtering. Reason for this strategy is that then the processing of consecutive frames is independent from processing of other frames and therefore a parallel processing of different frames is possible. This is reasonable for real-time applications.

Preferably, the positions of the pixels 70, 72 in the previous and successive frames are motion compensated. The motion vectors, as described with reference to FIG. 2, derive from an external motion estimator 7′. The motion vectors from the pixel 71 under processing in the current frame to the corresponding pixels in the previous and successive frames are indicated in FIG. 8 with corresponding arrows. Every method for motion estimation can be used for generation of the motion vectors, but preferably motion vectors from a multiple-reference motion estimation are used. It is also possible to use no motion estimation to save computational costs. In this case the pixels have the same spatial coordinates i,j as the actual pixel but are from different frames (different temporal coordinate).

After the generation of the weighting factor for the actual position (i,j,k+p) it is stored at this pixel position i,j in a temporal buffer Tₖ₊ₚ. Thus for each frame k and each of its reference frames k+p a buffer T_{i,j,k+p} for the temporal weighting factors is needed. As illustrated in equation (15), for filtering the actual pixel the temporal weighting factors for each reference frame at the actual position in the buffer are read out. Later on, three different strategies for computation of the temporal weighting factors are described.

In the following, first the generation of the spatial weighting factors will be explained in more detail.

FIG. 9 shows a schematic block diagram of the spatial weighting factor generator 23 according to a preferred embodiment of the present invention.

The generation of spatial weighting coefficients which should be stored in buffer B is extremely important. Weighting coefficients have to be greater than or equal to zero. For regions to be considered to remain unprocessed the spatial weighting coefficient must tend to zero. Thereby it is possible to prevent filtering by the regularizing filter for the related pixels and no smoothing is applied. To protect edges the absolute value of the gradient is used for spatial weighting factor generation. The computation can be derived from the block diagram in FIG. 9.

It has to be noted that this is just one possible implementation. Other variants are possible to protect other regions than edges or to minimize distortions. E.g. it is possible to use the local variance for protection of textured regions or information about the blocking level can be used for this case; further it is possible to use the blocking level to remove the protection of high gradients at block borders. In the implemented variant the computation of spatial weighting factors by gradient operations is done separately for horizontal 40 and vertical 41 direction. For gradient calculation a 3-tap filter is used with the coefficients 1, 0 and −1. It is possible to use different gradient filters but for low resolution material with low bitrate this symmetric variant is preferred.

The output is squared for each pixel as well for the horizontal and the vertical processing branch 42, 43. To protect image details marked for protection through an image analysis the calculated gradients can be modified in its size separately in horizontal and vertical direction by a multiply-add stage 44ab, 45ab. This is new compared to conventional methods to calculate spatial weighting factors used for Gaussian noise reduction. The external data X1, X2, Y1, Y2 must vary the gradient in a manner that in image areas which should be protected the results from 44b respectively 45b have a high value. In formula (5) X1, X2 and Y1, Y2 are denoted with μ_{X1}, ν_{X1}, μ_{X2}, ν_{X2}, respectively. The results of horizontal and vertical branches are summed up 46 and a constant value C is added by adding stage 47. This constant C is set to 1 in the proposed implementation. Finally the square root 48 and the inverse 49 are calculated.

FIG. 10 shows an alternative embodiment, where the spatial weighting factors 12 are stored in a look-up table. Alternatively to the spatial weighting factor generation described above pre-defined values from a look-up table can be used to prevent the computational complexity of the square, square root and/or the inverse. An example for this is depicted in FIG. 10. In this case after computing the gradients by horizontal 50 and vertical 51 gradient filters an address-operator 52 is used. This address-operator 52 uses the horizontal and vertical gradient outputs and external data from image analysis 8 to generate an address for a look-up table. The spatial weighting coefficients 12 are then read out from the look-up table 53 at the generated address position. The weighting coefficient 12 for each pixel generated like this is then stored in buffer B.

In the following, spatial part of the algorithm of the regularization filter 25 will be explained in more detail with reference to FIGS. 11 to 13. Generally, an actual position 60, i.e. a pixel, within the actual image to be smoothed is selected. Then within the image stored in buffer A, which is the original filtered image 4 submitted from the block noise filter 3 and/or the previously smoothed image 11 transmitted from the regularization filter 25 during the last iteration step, at least one further pixel 63 is selected and weighting factors 12 are obtained from buffer B. The smoothing of the actual position 60 is then based on the values of the at least one further position 63 and on the least one weighting factor 12.

It has to be noted, that the filter masks shown in FIGS. 11 to 13 indicating the selection of further pixels 63 and the election of weighting factors 12 are only examples and the present invention is not limited to the shown examples but encompasses any filter mask, where at least one further pixel and at least one spatial weighting factor are used independent of the position of the at least one further pixel. It is further to be noted that the position of the at least one further 63 and the position of the pixel, for which the weighting factor 12 was calculated do not necessarily have to be the same.

This concept will therefore first be explained in a general way and the non-limiting examples of the FIGS. 11 to 13 will be explained.

The image regularization is in the particular implementation of the invention based on the minimization of the total variation. The mathematical expression of total variation can be reduced to a recursive, adaptive filtering.

In this case recursive means results calculated previously are used to calculate new results. The image is filtered from upper left pixel (first line, first row) to the bottom right pixel (last line, last row) by a line-wise scanning. All values above the actual line and all values left from the actual pixel position in the actual line are already calculated/actualized. All values below the actual line and right from the actual pixel position in the actual line still have their initial value; this is either the initial input value or the value from the last iteration depending on the content of buffer A.

In this case adaptive means that the weighting coefficients are not fixed but they vary from calculation to calculation. In case of the regularizing filtering the coefficients will be read out or derived from Buffer B. The shape is predetermined by the filter mask and can be chosen depending on the specific application.

The general structure of the regularization can be described as follows: The current pixel value is set to a weighted sum of the initial input value (buffer C) for this pixel and a value which is derived by an adaptive filtering of the surrounding (partly already processed) pixel values (buffer A), i.e. of the at least one further pixel 63. The filter mask determines the support region of the adaptive filtering and may also include pixel positions that are not directly neighboured to the current pixel position 60. The adaptive filter coefficients are read-out or derived from the weights calculated earlier (buffer B). Thus the adaptive coefficients may also be derived from values at pixel positions that are not included in the filter mask. It has to be noted in this context, that in general the read-out position in buffer B does not have to be the same as the position of the filter tap, i.e. of the further pixels 63, as explained later in this document.

The general mathematical formulation is given in (16). Here the current position is denoted with the subscript i,j. The filter mask is given by h and the (adaptive) coefficients are denoted with b and are derived from the local values in buffer B with the offsets o₁ and o₂ relative to the filter tap position to adjust the read-out position in buffer B. N is the number of filter taps and [symbol] is the regularization rate. This formulation can be interpreted as mixing the initial value with a spatially recursive and adaptive weighted filtering of the surrounding pixel values, whereas some pixel values are (partially) excluded from the filtering by the adaptive filter coefficients, if they do not belong to the same class or object as the central pixel.

$${A}_{i , j} = d \cdot ( {C}_{i , j} + \frac{λ}{N} {\sum }_{n , m} {h}_{n , m} \cdot {b}_{{i - n - {o}_{1} ( n , m ) ,}_{j - m - {o}_{2} ( n , m )}} \cdot {A}_{i - n , j - m} ) \\ with d = {( 1 + \frac{λ}{N} {\sum }_{n , m} {h}_{n , m} \cdot {b}_{{i - n - {o}_{1} ( n , m ) ,}_{j - m - {o}_{2} ( n , m )}} )}^{- 1} \qquad ( 16 )$$

An example for such a filter mask is illustrated in FIG. 11. FIG. 11 shows the content of buffer A. At the beginning of the regularization the original or pre-processed image respectively sequence 4 is stored in buffer A. Then a linewise processing of the pixels stored in buffer A begins and the previous value of a pixel is overwritten by the newly calculated value. That means that buffer A contains partly pixels which in the actual iteration step are already processed and other pixels which in the actual iteration step have not yet been processed. This is shown in FIGS. 11 to 13. The actual processed pixel 60 is shown and sort of divides the pixels within the buffer into already processed pixels 61 prior to the actual pixel 60 and into pixels to be processed 62 in this iteration step after the actual processed pixel 60.

FIG. 11 shows the position P2 to P5 of the filter taps, i.e. of the further pixels 63, for computation of the actual pixel 60 at position P1. The values used for computation from buffer A are at positions P2 to P5. It has to be noted that the values at positions P2 and P5 in this iteration step are already processed. The values from buffer A are multiplied by the weights from buffer B. The position of the values read out from buffer B are not at the same position as that of the filter taps due to the mathematical derivation of the filter mask with central differences. The computation formula for the new value that will be stored at position P1 in buffer A can be calculated with the filter mask given in FIG. 11 by

A_{i,j}=d·(C_{i,j}+0.25λ(B_{i-1,j}A_{1-2,j}+B_{i+1,j}A_{i+2,j}+B_{i,j-1}A_{i,j-2}+B_{i,j+1}A_{i,j+2}))

with d=(1+0.25λ(B_{i-1,j}+B_{i+1,j}+B_{i,j+1}+B_{i,j-1}))⁻¹ (17)

In this formula i, j is the position of the center position (where i addresses the row and j the line). The values A stem from buffer A and the values B from buffer B. The values C at the center position result from buffer C (buffer of the unfiltered input image, see FIG. 4). The value [symbol] is the so called regularization rate.

By tuning the value of the regularization rate strength of convergence to the mathematical optimum can be controlled. The higher the regularization rate the higher the amount of processing. A higher value of λ results in a stronger smoothing of the image. The value of λ can be constant, or be higher or lower in certain image regions to protect image content in these regions. The value computed by calculation rule in formula (17) is stored at position (i, j) in buffer A. The position of the pixel to be computed is set to the position directly right of the actual one (i+1, j). After reaching the end of line the next position is the first row in the line below (0, j+1).

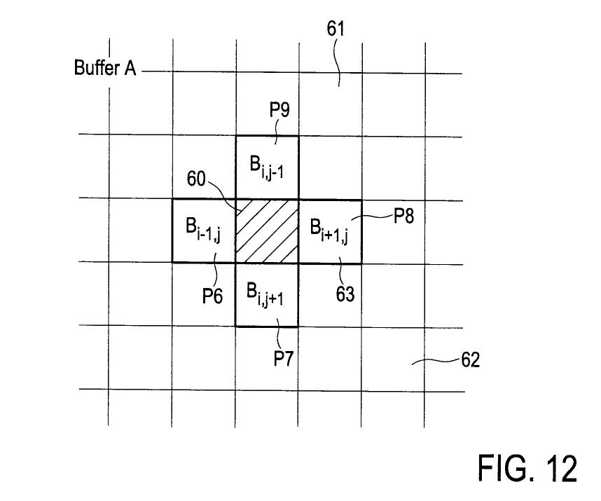

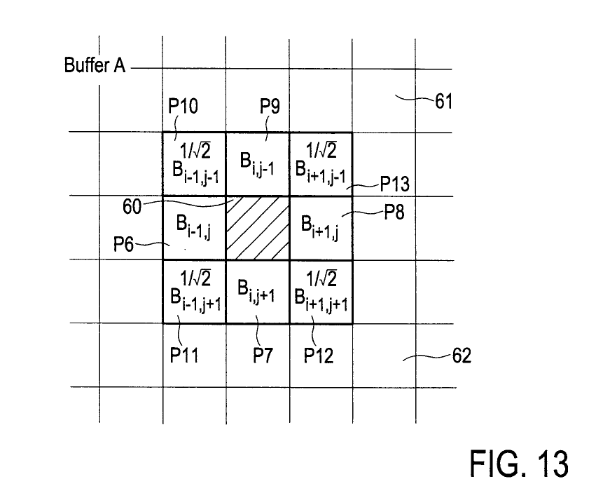

The filter mask from FIG. 11 and the calculation rule in formula (17) have an effect on a large area and neglect diagonals. Therefore additional variants can be implemented, whereby two non-limiting examples are shown in FIGS. 12 and 13.

Whereas formula (17) is based on a mathematical derivation, the filter mask depicted in FIGS. 12 and 13 are based on heuristic derivations and the optimization of the regularizing result is based on visual criteria.

The related rules of calculation are given in formulas (18) and (19).

Rule of calculation for filter mask depicted in FIG. 12:

A_{i,j}=d·(C_{i,j}+0.25λ(B_{i-1,j}A_{i-1,j}+B_{i+1,j}A_{i+1,j}B_{i,j-1}A_{i,j-1}+B_{i,j+1}A_{i,j+1}))

with d=(1+0.25λ(B_{i-1,j}+B_{i+1,j}+B_{i,j+1}+B_{i,j-1})⁻¹ (18)

Rule of calculation for filter mask depicted in FIG. 13:

$${A}_{i , j} = d \cdot {C}_{i , j} + 0.25 \cdot λ \cdot d \cdot ( {B}_{i - 1 , j} {A}_{i + 1 , j} + {B}_{i + 1 , j} {A}_{i + 1 , j} + {B}_{i , j - 1} {A}_{i , j - 1} + {B}_{i , j + 1} {A}_{i , j + 1} ) + \frac{1}{\sqrt{2}} \cdot 0.25 \cdot λ \cdot d \cdot ( \begin{matrix}{B}_{i - 1 , j - 1} {A}_{i - 1 , j - 1} + {B}_{i + 1 , j + 1} {A}_{i + 1 , j + 1} + \\ {B}_{i + 1 , j - 1} {A}_{i + 1 , j - 1} + {B}_{i + 1 , j + 1} {A}_{i + 1 , j + 1}\end{matrix} ) \\ with d = {( 1 + 0.25 λ ( \begin{matrix}{B}_{i - 1 , j} + {B}_{i + 1 , j} + {B}_{i , j + 1} + {B}_{i , j - 1} + \\ \frac{1}{\sqrt{2}} ( {B}_{i - 1 , j - 1} + {B}_{i + 1 , j - 1} + {B}_{i + 1 , j + 1} + {B}_{i + 1 , j - 1} )\end{matrix} ) )}^{- 1} \qquad ( 19 )$$

Now, the generation of the temporal weighting factors 112 will be explained in more detail.

In FIG. 14 a first embodiment for the temporal weighting factor generator 123 is presented. It consists of a temporal difference computation unit 102 for computing the temporal difference diff_t between at least two frames 100, 101. The temporal difference computation unit 102 hereby is fed with motion information 7′a and preferably also other data from an external analysis 8. The temporal difference is then submitted to a square operation unit 103 which generates the square of the temporal difference. Optionally, afterwards a further unit (not shown in the figure) can be provided to multiply the square with a constant factor α. An adding unit 104 adds a constant to prevent division by 0. A square root unit 106 generated the square root and a reciprocal unit 107 calculated the reciprocal of the information submitted from the square root unit 106. For the temporal difference computation diff_t three methods, which will be described later, can be used. For this difference computation motion vectors, the actual and/or reference frames are required.

External information 115 from the image analysis can be used to modify the constant c and a factor α in a certain way. E.g. if a region/pixel should be protected, by setting c and/or α to a high value, the weighting factor will have a very low value and thus no or less smoothing/filtering will be applied to the pixel. In the opposite case it is also possible to “generate” a high weighting factor (resulting in strong smoothing) even for high gradient values by setting α to a value lower than 1.

This strategy makes sense in case a high temporal difference is caused by artifacts (e.g. flicker) that are detected by an external analysis and thus should be smoothed. But it is also possible to prevent smoothing of details caused by erroneous motion vectors. If a reliability measurement (e.g. DFD) of the motion vectors is carried out, this result from the external analysis can be used to control the factors α and c. In case the vector is reliable, these factors α and c will get a low value resulting in a higher weighting factor. Otherwise the factors α and c will get a high value resulting in a low weighting factor. Further possibilities for usage of external information are also described in the EP application. In case no external information is used, c and the factor α are both set to 1.

With this schematic the following equation can be solved:

$${T}_{k + p} = \frac{1}{\sqrt{{c}^{2} + α \cdot {diff\_t}_{k + p}^{2}}} \qquad ( 20 )$$

With diff_tₖ₊ₚ the temporal difference computed by one of the three methods described in the following and constant c that can be set to one in a preferred, non-limiting embodiment to prevent division by zero. The input frames 100 and 101 depend on the method chosen for temporal difference computation. Tₖ₊ₚ is the resulting temporal weighting factor used for spatio-temporal filtering for the reference frame at time instance k+p.

The circuit as described with reference to FIG. 14 is just one possible implementation. As illustrated in the second embodiment in FIG. 15, it is also possible to feed the result of the temporal differences from the temporal difference computation unit 102 to a look-up table 110 to get the temporal weighting factor 112 to save computational costs.

In the next section the temporal difference computation is described.

In the following with reference to FIGS. 16 to 18, different possibilities of generation of the temporal weighting factors 112 are described.

A first possibility is described with reference to FIG. 16. As previously described for the spatial weighting coefficients 12, the spatial weighting coefficients are determined by pixel differences in the local neighbourhood. This scheme is directly adapted to the temporal case. Equation (21) describes this situation:

diff_{—}tₖ₊ₚ=|A_{i+mvX}_{ₚ}_{,j+mvY}_{ₚ}_{,k+p}−A_{i+mvX}_{ₚ₊₁}_{,j+mvY}_{ₚ₊₁}_{,k+p+1}| (21)

In this case two pixel values from two different reference frames are used for computation of the temporal difference that is used in the temporal weighting factor generator 123 described in the previous section. A is the pixel value in the first reference frame, i,j is the position of the actual pixel in the actual frame with time instance k. mvXₚ and mvYₚ are the motion vectors from the actual frame at actual time instance k to the first reference frame at time instance k+p. mvXₚ₊₁ and mvYₚ₊₁ are the motion vectors to the second reference frame at time instance k+p+1.

For a better understanding, the computation of the temporal weighting factors T is depicted in FIG. 16. In this figure the motion vectors 80 from a multiple-reference frame motion estimation are used to compute the motion compensated differences 81. Note that it is also possible to use other motion vector components. E.g. the differences could be computed by using the motion vector from frame k to k+p to get the motion compensated position in the first reference frame k+p and then use the motion vector from reference frame k+p to frame k+p+1 at this position to get the motion compensated pixel in reference frame k+p+1. This scheme would be a concatenation of two motion vectors.

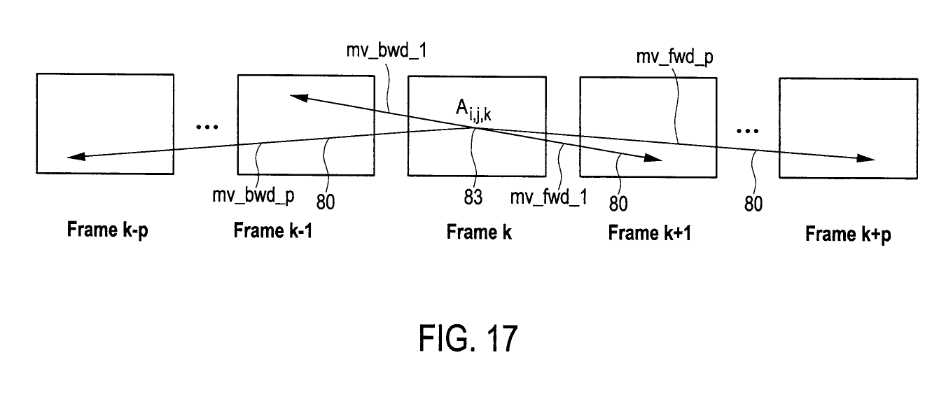

With reference to FIG. 17 now a second possibility of calculating the temporal difference will be described. The weighting factor generation for the temporal directly neighboured frame is a special case. In this case the difference computation as it is described in the following and in equation (22) is used for these weighting factors.

This strategy can be described best with equation (22) and FIG. 17. In this case only the pixels in the reference frame must be motion compensated, which is shown in FIG. 17 with corresponding motion vectors 80 from the actual pixel 83 to the reference frames. The other input value for the temporal weighting factor generation is the pixel 83 at the actual position i,j in the actual frame at time instance k.

diff_{—}tₖ₊ₚ=|A_{i,j,k}−A_{i+mvX}_{ₚ}_{,j+mvY}_{ₚ}_{,k+p}| (22)

mvXₚ and mvYₚ are the motion vectors between actual frame and reference frame at time instance k+p. This simple measure is a pixel based absolute difference and is denoted also as displaced pixel difference (DPD) in the literature. Advantages of this strategy are the simplicity of the computation and the direct reliability testing of the correctness of the motion vectors by simple difference operations.

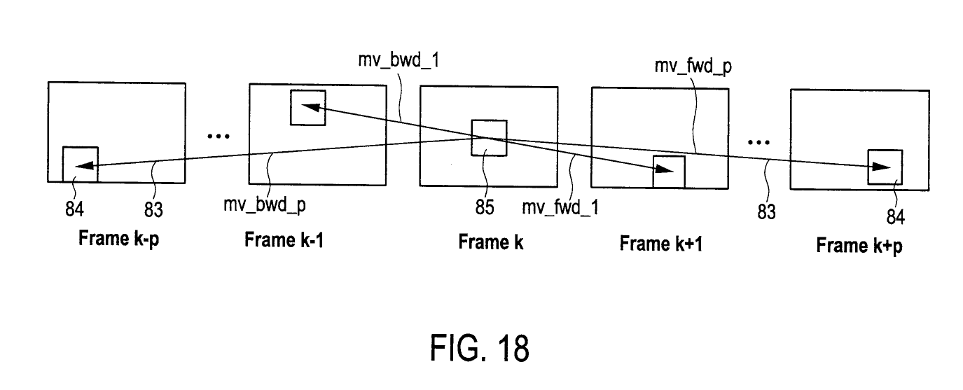

Now, a third possibility of calculating the temporal difference with be described with reference to FIG. 18. To get a better robustness against artifacts the temporal differences diff_{—k+p} can be computed by using a weighted sum of absolute differences (weighted SAD). This strategy can be found in equation (23) and is illustrated in FIG. 18, too. For this method, a window comprising at least one pixel is defined having a height of r pixels and a width of s pixels, r and s being equal to or larger than one.

The size of the window (r,s) is 3×3 in a preferred embodiment but the window can be of any size r,s. In this case not only the difference between the actual pixel and the (motion compensated) pixel in each reference frame is computed, but also the differences of surrounding pixels in the window.

$${diff\_t}_{k + p} = {\sum }_{r , s} {w}_{r , s} \vert {A}_{i + r , j + s , k} - {A}_{i + r + {mvX}_{p} , j + s + {mvY}_{p} , k + p} \vert \qquad ( 23 )$$

A window 84 with possible weighting coefficients for the weighted SAD computation is depicted in FIG. 18. The motion vectors 82 from the window 85 within the actual frame to the windows 84 within the reference frames are also shown. These coefficients are used in a preferred embodiment. Another example for a window is a window that is not weighted (all coefficients are 1). But it is also possible to reuse the DFD-value from the motion estimation to save computational costs. A possible example for such a window having a size of 3×3 is shown now:

$$\begin{matrix}1 & 2 & 1 \\ 2 & 4 & 2 \\ 1 & 2 & 1\end{matrix}$$

But as previously explained, any other size and/or values are possible.

With reference to FIGS. 19 and 20 now different application scenarios will be described.

The spatio-temporal smoothing filter can be used in different scenarios. For Gaussian noise reduction a stand-alone application is possible to reduce the artifacts very efficiently compared to state-of-the-art spatial and/or temporal methods (see FIG. 2). If the method described in this application should be used for coding artifact reduction, a combination with spatial and/or temporal pre-processing is proposed. The reason for this is as follows. As illustrated in the EP application, the regularization protects smoothing of steep transitions due to the mathematical formulation of the total variation. In (highly) compressed image sequences, two different undesired steep transitions may occur. The first one is a spatial steep transition, and is called blocking due to the block-based coding scheme; the second one is a temporal undesired steep transition, which is flicker due to different coding of consecutive frames. Possible combinations to reduce these undesired steep transitions will now be described in detail. It should be noted that these combinations are important parts of the invention. But these frameworks are just examples and should not limit the invention.

In case of digital noise reduction, steep transitions that may result from e.g. blocking artifacts should be reduced. Because the stand-alone application of the 3D-Regularizer prevents smoothing of high spatial transitions, a combination with a conventional (adaptive) de-blocking technique as depicted in FIG. 19 is preferred.

The input image 2 is submitted to a spatial deblocking unit 30. The spatial deblocking unit 30 is provided for filtering discontinuous boundaries within the input image 2. The deblocking unit 30 can be any type of for example low-pass filter which is adapted to reduce the blocking artifacts. Preferably, a local adaptive low-pass filtering only across block boundaries is carried out. The reason for this pre-processing is the smoothing of discontinuities at block boundaries and to protect edges and details as far as possible. Any common de-blocking scheme can be used as block noise reduction algorithm, adaptive schemes with a short filter for detailed areas, a long filter for flat areas and a fallback mode are preferred.

The usage of an (adaptive) spatial de-blocking as pre-processing has the following advantages. The motion estimation is executed on an artifact reduced sequence leading to motion vectors with a higher accuracy. As described before, the motion estimation can be a conventional predictive block-matching technique using only one previous frame for backward estimation and one successive frame for forward estimation, but also a multiple-reference frame motion estimation using multiple previous and successive reference frames. A typical number is three previous and three successive frames resulting in seven input frames to the spatio-temporal regularizer, but this is just an example and will not limit the invention. Additionally, strong blocking artifacts are reduced by the conventional de-blocker and thus the smoothing by the spatio-temporal regularizer is much more effective reducing remaining blocking and ringing artifacts. Moreover, it is possible to de-block all input frames of the spatio-temporal regularizer (previous and successive frames) and thus the computation of the temporal weighting factors is done on input frames with less (coding) artifacts leading to better weighting factors.

In addition to undesired steep transitions in the spatial direction (blocking artifacts) undesired steep transitions in the temporal domain (flicker) may occur, too. Thus a temporal pre-processing to reduce this flicker artifact as depicted in FIG. 20 can be applied, too. In this case the pre-processing consist of a conventional spatial de-blocking unit 30, that is image content and blocking level adaptive in a preferred embodiment and a motion compensated temporal (weighted) FIR-filter 31. The motion estimation can be of any type (e.g. optic flow based, global motion estimation or phase plane correlation) but it is preferably a predictive block-matching technique using multiple input frames. The spatio-temporal regularizer 5′ is then applied to the spatial and temporal smoothed input sequence. It is possible to use different motion vectors for the pre-processing (temporal filtering) and the spatio-temporal regularization. In a preferred embodiment the vector field is smoothed before it is used for the spatio-temporal regularizer 5′. This smoothing is not part of the invention and is therefore described only very shortly. The vector field of the multiple-reference frame motion estimation can have a very high resolution (e.g. 1 motion vector per pixel). Because of this the vector field may have outliers. These outliers can be reduced by e.g. median filtering of the vector field or selecting the vector with the highest occurrence in a support region as output. Thereby it is possible to get a smoother vector field.

With the present invention thus an improved image processing becomes possible.

The advantages of this invention are derivation and implementation of a new spatio-temporal regularization method based on heuristic assumptions in combination with an image model based Least Square approach. Result of this derivation is a spatio-temporal recursive filter structure with adaptive filter coefficients that is applied once or several times to each frame. In literature no spatio-temporal derivation that is similar to the proposed derivation can be found.

Computation of these spatial and/or adaptive filter coefficients depending on image/pixel information and/or information from an external image analysis. This external analysis can be used to detect and smooth artifacts using the spatio-temporal regularization or to protect image details like texture from smoothing.

Combination of spatio-temporal regularization with a spatial and temporal pre-processing to smooth undesired edges in spatial (blocking artifacts) and temporal (flickering) direction. This strategy was already used for the Regularization described in the EP application and is now extended to the spatio-temporal or temporal case.

Integration of several strategies for computation of temporal weighting factors into this spatio-temporal regularization method based on heuristic assumptions. These strategies are motion compensated difference operations instead of mathematically derived operations like directional derivatives in motion direction as it is done in prior art. The directional derivatives are mathematical correct but lead to completely different or even erroneous results in case of fast motion.

Usage of motion vectors from a multiple reference frame motion estimation based on block-matching. Differences to state-of-the-art are that this new regularization method is robust against erroneous motion vectors and distortions in the vector field. Moreover, in literature no method based on a multiple-reference frame motion estimation is described.

Frame-wise processing using a certain number of input frames as depicted in FIG. 8. This means only the actual frame and a certain number of previous and/or successive frames are used for processing of the actual output frame. That is very important for (a) short latency time and (b) real-time applications. In contrast to this, methods described in state-of-the art sometimes do require the whole input sequence for computation of each frame because they are based on mathematical assumptions.

By applying this method to degraded input sequences the result is a very strong artifact reduction compared to state-of-the-art-methods. In addition to the reduction of blocking and ringing flicker can strongly be reduced, too. Moreover, no/very few loss of sharpness, contrast and details can be perceived as it is the case for most of the spatial methods.

Due to the spatio-temporal processing the artifact reduction is relatively hardware and memory efficient compared to pure temporal methods because pixels from the actual frame having the same image information as the actual pixel are used for filtering, too. Thus, less frames/pixels are required in the temporal direction. Moreover, due to the temporal recursive filtering the frame number can be additionally reduced and due to the temporal weighting factor generation a high stability can be reached. In contrast to pure temporal recursive filtering, no run-in phase is required for the processing described in this invention. Another advantage is that the spatio-temporal regularizer has an integrated implicit image content analysis. Thus this method can be used for reduction of several artifacts like ringing, mosquito noise, jaggies at edges, and even blocking artifacts and flicker. By a combination with conventional methods the artifact reduction is even higher. A further advantage is that this method can handle non-smooth motion vector fields. This is very important because in real sequences non-smooth vector fields occur very often (e.g. object borders of moving objects on a still background). Because the present invention can handle these vector fields it is possible to use very accurate motion vector fields from a block-matching process. This technique is preferably applied in consumer electronics. Therefore the motion vectors can be re-used for other algorithms like de-interlacing or frame rate conversion. But advantageous of the present invention is that due to the usage of multiple frames a higher flicker reduction is possible and due to the differences in the temporal and spatial terms a higher filter effect and artifact reduction can be obtained by our method. Moreover, due to the temporal weighting factor generation the robustness to erroneous motion vectors is very high.

The present method and apparatus can be implemented in any device allowing to process and optionally display still or moving images, e.g. a still camera, a video camera, a TV, a PC or the like.

The present system, method and computer program product can specifically be used when displaying images in non-stroboscopic display devices, in particular Liquid Crystal Display Panels (LCDs), Thin Film Transistor Displays (TFTs), Color Sequential Displays, Plasma Display Panels (PDPs), Digital Micro Mirror Devices or Organic Light Emitting Diode (OLED) displays.

The above description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. Image processing method,
comprising the steps of
generating adaptive temporal filter coefficients and
applying a recursive filter at least once to an image frame using the generated temporal filter coefficients.

2. Method according to claim 1,
further comprising the steps of
generating adaptive spatial filter coefficients and
applying said recursive filter at least once to said image frame using the generated temporal and spatial filter coefficients.

3. Method according to any of the preceding claims,
comprising the step of repeating the filter coefficient generation and the recursive filtering at least once.

4. Method according to any of the preceding claims,
wherein the step of generating the adaptive temporal filter coefficients bases on at least one successive and/or at least one preceding frame.

5. Method according to any of the preceding claims,
wherein the step of generating the adaptive temporal filter coefficients comprises calculating a temporal difference between a pixel in the current frame under processing and a pixel within at least one previous and/or successive frame and follows the equation
$${T}_{k + p} = \frac{1}{\sqrt{{c}^{2} + α \cdot {diff\_t}_{k + p}^{2}}} ,$$
where Tₖ₊ₚ is the temporal filter coefficient, c and α are constants or adaptively generated based on external analysis information and diff_tₖ₊ₚ is the temporal difference between the current frame k and the frame k+p, p being a natural number.

6. Method according to claim 5,
wherein the step of calculating the temporal difference bases on the difference between two consecutive reference frames.

7. Method according claim 6,
wherein the temporal difference is calculated by
diff_{—}tₖ₊ₚ=|A_{i+mvX}_{ₚ}_{,j+mvY}_{ₚ}_{,k+p}−A_{i+mvX}_{ₚ₊₁}_{,j+mvY}_{ₚ₊₁}_{,k+p+1}| (21)
where A is the pixel value in the first reference frame, i,j is the position of the actual pixel in the actual frame with time instance k, mvXₚ and mvYₚ are the motion vectors from the actual frame at actual time instance k to the first reference frame at time instance k+p. mvXₚ₊₁ and mvYₚ₊₁ are the motion vectors to the second reference frame at time instance k+p+1.

8. Method according to claim 5,
wherein the step of calculating the temporal difference bases on the difference between the actual frame and a reference frame.

9. Method according claim 8,
wherein the temporal difference is calculated by
diff_{—}tₖ₊ₚ=|A_{i,j,k}−A_{i+mvX}_{ₚ}_{,j+mvY}_{ₚ}_{,k+p}| (22)
where A is the pixel value in the first reference frame, i,j is the position of the actual pixel in the actual frame with time instance k and mvXₚ and mvYₚ are the motion vectors between actual frame and reference frame at time instance k+p.

10. Method according to claim 5,
wherein the step of calculating the temporal difference bases on a weighted summed absolute difference between the actual frame and a reference frame.

11. Method according claim 10,
wherein the temporal difference is calculated by
$${diff\_t}_{k + p} = {\sum }_{r , s} {w}_{r , s} \vert {A}_{i + r , j + s , k} - {A}_{i + r + {mvX}_{p} , j + s + {mvY}_{p} , k + p} \vert \qquad ( 23 )$$
where A is the pixel value in the first reference frame, i,j is the position of the actual pixel in the actual frame with time instance k, mvXₚ and mvYₚ are the motion vectors from the actual frame at actual time instance k to the first reference frame at time instance k+p and r and s indicate the size of a window of pixels.

12. Method according to any of the preceding claims,
wherein the adaptive temporal filter coefficients are calculated based on at least one motion compensated frame.

13. Method according to any of the preceding frames,
further comprising the step of spatially and/or temporally pre-processing the image frame prior to the generation of the filter coefficients.

14. Apparatus for image processing,
comprising a temporal weighting factor generator for generating adaptive temporal filter coefficients and
a regularization filter for applying a recursive filter at least once to an image frame using the generated temporal filter coefficients.

15. Device, preferably a camera or a television,
comprising a display and an apparatus according to claim 14.

16. Apparatus for image processing comprising
means for generating adaptive temporal filter coefficients and
means for applying a recursive filter at least once to an image frame using the generated temporal filter coefficients.

17. A computer program product stored on a computer readable medium which causes a computer to perform the steps of
generating adaptive temporal filter coefficients and
applying a recursive filter at least once to an image frame using the generated temporal filter coefficients.

18. Computer readable storage medium comprising a computer program product according to claim 17.

19. Method for reducing compression artifacts in a video signal, comprising the steps of:
analysing the input image with respect to image areas by an image analyser to obtain image analysis information,
filtering discontinuous boundaries within the input image, and
smoothing the filtered image, wherein obtained image analysis information is used in one or both of said steps of filtering and/or smoothing.

20. Method according to claim 19,
wherein the step of smoothing bases on a minimization of the total variation of the filtered image.

21. Method according to claim 19 or 20,
further comprising the step of repeating the step of smoothing at least once by smoothing the previously smoothed image.

22. Method according to claim 21,
wherein the step of smoothing uses an adaptive, recursive filtering.

23. Method according to any of claims 19 to 22,
wherein the step of smoothing comprises selecting the level of smoothing of the filtered image based on the gradient values of the filtered image and/or a previously smoothed image.

24. Method according to claim 23,
wherein the step of selecting comprises selecting a high level of smoothing for low gradient values and selecting a low level of smoothing for high gradient values.

25. Method according to claim 23 or 24,
further comprising the step of generating weighting factors indicating the level of smoothing.

26. Method according to claim 25,
further comprising the steps of
selecting an actual position within the actual image to be smoothed,
selecting at least one further position within the filtered image and/or the previously smoothed image,
obtaining at least one weighting factor and
smoothing the actual position based on the values of the at least one further position and the at least one weighting factor.

27. Method according to claim 26,
wherein the smoothing of the actual position is accomplished according to the following equation:
$${A}_{i , j} = d \cdot ( {C}_{i , j} + \frac{λ}{N} {\sum }_{n , m} {h}_{n , m} \cdot {b}_{{i - n - {o}_{1} ( n , m ) ,}_{j - m - {o}_{2} ( n , m )}} \cdot {A}_{i - n , j - m} ) \\ with d = {( 1 + \frac{λ}{N} {\sum }_{n , m} {h}_{n , m} \cdot {b}_{{i - n - {o}_{1} ( n , m ) ,}_{j - m - {o}_{2} ( n , m )}} )}^{- 1} \qquad ( 16 )$$
whereby the current position is denoted with the subscript i,j, the filter mask h with its local support region n, m and the adaptive weighting factors are denoted with b and are derived from the filtered image and/or a previously smoothed image and o₁ and o₂ being offsets to adjust the read-out position for the adaptive weighting factors b relative to the position of the at least one further pixel, N is the number of the at least one further pixel positions and [symbol] is the regularization rate.

28. Method according to claim 27,
wherein the smoothing of the actual position is accomplished according to the following equation:
A_{i,j}=d·(C_{i,j}+0.25λ(B_{i-1,j}A_{i-2,j}+B_{i+1,j}A_{i+2,j}+B_{i,j-1}A_{i,j-2}+B_{i,j+1}A_{i,j+2}))
with d=(1+0.25λ(B_{i-1,j}+B_{i+1,j}+B_{i,j+1}B_{i,j-1}))⁻¹ (17).

29. Method according to claim 27,
wherein the smoothing of the actual position is accomplished according to the following equation:
A_{i,j}=d·(C_{i,j}+0.25λ(B_{i-1,j}A_{i-1,j}+B_{i+1,j}A_{i+1,j}+B_{i,j-1}A_{i,j-1}+B_{i,j+1}A_{i,j+1}))
with d=(1+0.25λ(B_{i-1,j}+B_{i+1,j}+B_{i,j+1}+B_{i,j-1}))⁻¹ (18).

30. Method according to claim 27,
wherein the smoothing of the actual position is accomplished according to the following equation:
$${A}_{i , j} = d \cdot {C}_{i , j} + 0.25 \cdot λ \cdot d \cdot ( {B}_{i - 1 , j} {A}_{i + 1 , j} + {B}_{i + 1 , j} {A}_{i + 1 , j} + {B}_{i , j - 1} {A}_{i , j - 1} + {B}_{i , j + 1} {A}_{i , j + 1} ) + \frac{1}{\sqrt{2}} \cdot 0.25 \cdot λ \cdot d \cdot ( \begin{matrix}{B}_{i - 1 , j - 1} {A}_{i - 1 , j - 1} + {B}_{i + 1 , j + 1} {A}_{i + 1 , j + 1} + \\ {B}_{i + 1 , j - 1} {A}_{i + 1 , j - 1} + {B}_{i + 1 , j + 1} {A}_{i + 1 , j + 1}\end{matrix} ) \\ with d = {( 1 + 0.25 λ ( \begin{matrix}{B}_{i - 1 , j} + {B}_{i + 1 , j} + {B}_{i , j + 1} + {B}_{i , j - 1} + \\ \frac{1}{\sqrt{2}} ( {B}_{i - 1 , j - 1} + {B}_{i + 1 , j - 1} + {B}_{i + 1 , j + 1} + {B}_{i + 1 , j - 1} )\end{matrix} ) )}^{- 1} . \qquad ( 19 )$$

31. Method according to any of claims 19 to 30,
further comprising the step of selecting the level of smoothing based the analysis information submitted by the image analyser,
whereby preferably a low grade of smoothing is selected for image areas having textures and/or details.

32. Apparatus for reducing compression artifacts in a video signal, comprising
an image analyser for analysing the input image with respect to image areas to obtain image analysis information,
a block noise filter for filtering discontinuous boundaries within the input image, and
a regularizer for smoothing the filtered image,
wherein said block noise filter and/or said regularizer are adapted for using obtained image analysis information.
